(19) United States
(12) Patent Application Publication
(10) Pub. No.: US 2013/0065777 A1
(43) Pub. Date: Mar. 14, 2013

(54) NANOSTRUCTURE BIOSENSORS AND SYSTEMS AND METHODS OF USE THEREOF

(71) Applicants: Hatice Altug, Watertown, MA (US); Ahmet Ali Yanik, Brighton, MA (US); Min Huang, Boston, MA (US); Alp Artar, Brighton, MA (US); John H. Connor, Newton, MA (US)

(72) Inventors: Hatice Altug, Watertown, MA (US); Ahmet Ali Yanik, Brighton, MA (US); Min Huang, Boston, MA (US); Alp Artar, Brighton, MA (US); John H. Connor, Newton, MA (US)

(73) Assignee: TRUSTEES OF BOSTON UNIVERSITY, Boston, MA (US)

(21) Appl. No.: 13/513,721

(22) PCT Filed: Dec. 3, 2010
(86) PCT No.: PCT/US10/58934

§ 371 Date: Nov. 27, 2012

Related U.S. Application Data
(60) Provisional application No. 61/266,967, filed on Dec. 4, 2009.
(60) Provisional application No. 61/288,101, filed on Dec. 18, 2009.
(60) Provisional application No. 61/393,734, filed on Oct. 15, 2010.

(51) Int. Cl. C40B 40/10; C40B 40/04; C40B 30/04; C40B 40/00; C40B 40/06; B82Y 15/00

(52) U.S. Cl. 506/9; 506/13; 506/16; 506/18; 506/15; 977/781; 977/920

(57) ABSTRACT

A sensor scheme combining nano-photonics and nano-fluidics on a single platform through the use of free-standing photonic crystals is described. By harnessing nano-scale openings, both fluidics and light can be manipulated at sub-wavelength scales. The convective flow is actively steered through the nanohole openings for effective delivery of the analytes to the sensor surface, and refractive index changes are detected in aqueous solutions. Systems and methods using cross-polarization measurements to further improve the detection limit by increasing the signal-to-noise ratio are also described.

### GOVERNMENT SUPPORT

This invention was made with Government support under NSF CAREER Award ECCS-0954790 awarded by the National Science Foundation (NSF), and under grant EEC-08 12056 awarded by the NSF Engineering Research Center on Smart Lighting. The Government has certain rights in the invention.

### FIELD OF THE INVENTION

The present invention relates generally to the field of biosensors, and in particular to systems and methods for overcoming mass transport limitations of on-chip biosensors with actively controlled, surface-targeted nanofluidics, methods of making biosensors, and apparatuses and methods for detection of biomolecular targets using nanoplasmonics.

### BACKGROUND

The ability to detect biological target molecules, such as DNA, RNA, and proteins, as well as nanomolecular particles such as virions, is fundamental to our understanding of both cell physiology and disease progression, as well as for use in various applications such as early and rapid detection of disease outbreaks and bioterrorism attacks. For example, early detection of infectious viral diseases is of great importance in terms of public health, homeland security, and the armed forces. A number of recent outbreaks of viral diseases (e.g., H1N1 flu, H5N1 flu and SARS) in recent years have raised significant fears that such viruses could rapidly spread and turn into a pandemic, similar to 1918 Spanish flu that killed more than 50 million people¹.

Such detection, however, is limited by the need to use labels, such as fluorescent molecules or radiolabels, which can alter the properties of the biological target, e.g., conformation, and which require additional, often time-consuming, steps, as well substantial equipment outlay. Traditional detection methods such as cell culturing, enzyme-linked immunosorbant assays (ELISA), and polymerase chain reaction (PCR) are not readily compatible with point-of-care use, without the existence of extensive infrastructure^{3,4}. Cell culturing is a time consuming, highly specialized and labor intensive process. In some cases, viruses cannot be cultured at all⁵. ELISA products require multiple steps and reagents, which can have a potential to create quenching interactions among each other⁶. PCR, another commonly used and powerful diagnostic tool, based on detection of nucleic fragments in samples, requires significant sample preparation, and can be confounded by inhibitors within a sample, such as a clinical sample⁷. In addition, PCR also provides only an indirect test of infections, as viral nucleic acid fragments can be present in the host organism after the infection has been “cleared” or effectively neutralized⁸⁻¹⁰. In addition, while PCR is a robust and accurate technique in detecting known strains, it is not always adaptable to newly emerged or highly divergent strains of an infections agent. One example is the description of a new strain of Ebola that was not identified in PCR-based diagnostics¹¹.

DNA and protein microarray technologies are actively being used by biologists and researchers today for high-throughput screening of biomarkers for drug discovery, disease research, and diagnosis, thereby converting the presence of target biomolecules to a measurable and quantifiable signal. The importance of high-throughput platforms has been demonstrated by the success of gene arrays in the analysis of nucleic acids, and to some degree, analysis of proteins. However, most detection systems available today for use in these high-throughput systems operate by the same guiding principle, whereby the surface of a microarray is scanned and fluorescence measured from labeled analytes or biomolecules. Fluorescent labeling is a costly and time-consuming step that sometimes proves to be prohibitively difficult and expensive for use in these technologies. In addition, detecting analytes through secondary probes is intrinsically complex, requiring multiple layers of interacting components that provide specificity without interfering with one another.

In recent years, label-free biosensors combined with innovative signal transduction methods have been proposed to push the detection limits down to femto-molar concentrations of analytes. Concurrently, researchers have also been integrating such sensitive and compact nanosensors with micro-fluidics for automated sample handling.

While micro-fluidics can enable portable and lab-on-a-chip systems, recent theoretical and numerical calculations indicate that the effects of various fluidic integration schemes must be taken into account because they can fundamentally limit the sensors performance. For nano-sensors embedded in conventional microfluidic channels, the detection limit is often determined by the analyte (mass) transport limitations as opposed to the detection capabilities of the sensors.

As the analytes are collected by the functionalized sensors, depletion zones form around the sensing area. Depletion zones, where the analytes transport diffusively, expand with time until the growth is halted by the convective flow. In micro-fluidic channels supporting laminar flow profile, the convective flow parallel to the surface is weaker close to the channel edge. Accordingly, the depletion zones extend significantly towards the center of the channel, causing dramatically lower amounts of analytes to reach the sensing surface per unit time. Consequently, if no method is introduced to actively direct the convective flow towards the surface of the nano-micro size sensors, analytes at low concentrations may need weeks-to-years to diffuse due to mass (analyte) transport limitations imposed by the depletion zones.

Within the last decade, several highly sensitive optical label-free nano-sensors have been introduced, such as dielectric resonators supporting whispering-gallery modes, metallic nano-structures supporting localized/propagating surface plasmons, and photonic crystals (PhC) supporting cavity, waveguide and guided resonance modes. Among these, nanohole array based platforms are offering more freedom to manipulate the spatial extent and the spectral characteristics of the electromagnetic fields.

Existing nanohole array-based platforms are formed using FIB lithography. FIB lithography, however, is operationally slow.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Described herein are label-free, optofluidic-nanoplasmonic sensors that can directly detect biomolecular targets without the use of labels. The sensor platforms described herein are based on extraordinary light transmission effects using plasmonic nanoholes, and can utilize unlabeled capture agents, such as antibodies or fragments thereof, for detection of biomolecular targets. For example, the novel nanoplasmonic biosensors and methods thereof described herein can be used to detect intact viruses from biological media at clinically relevant concentrations with little to no sample preparation. The nanoplasmonic biosensors and methods described herein are capable of detecting highly divergent strains of rapidly evolving viruses, as demonstrated herein by detection and recognition of small enveloped RNA viruses (e.g., vesicular stomatitis virus and pseudo-typed Ebola), as well as enveloped DNA viruses (e.g., vaccinia virus), within a dynamic range spanning at least three orders of magnitude. Remarkably, the quantitative detection methods described herein permit the detection of intact viruses at low concentration limits (10⁵ PH J/ml), which enables not only sensing of the presence of virions in analyzed samples, but also the intensity of the infection process. Further, the non-destructive nature of the nanoplasmonic biosensors and systems described herein allow the preservation of structural aspects of a biomolecular target being analyzed, such as a viral structure or a nucleic acid load (genome) for further studies. The nanoplasmonic biosensors and systems described herein permit high signal:noise measurements without any mechanical or optical isolation, and thus, opens up opportunities for detection of a broad range of biomolecules, such as pathogens, in any biology lab.

High-throughput DNA and protein analysis technologies, such as microarray technologies, are actively being used by biologists and researchers today for high-throughput screening of biomolecules and analytes for drug discovery, disease research, and diagnosis. Most detection systems available operate by the same guiding principle, whereby they scan the surface of a microarray and measure fluorescence, or some other label, from biomolecules present on the array surface. Fluorescent labeling is a costly and time-consuming step that sometimes proves to be prohibitively difficult and expensive. Thus, the ability to rapidly detect biomolecular targets using label-free systems can have many practical applications and advantages. Further, label-free systems provide easier monitoring and quantification methods for detecting biomolecular interactions between such targets, such as antigen-antibody, receptor-ligand, virus-cell, and protein-DNA binding interactions.

Label-free biosensors have emerged as promising tools for detecting and analyzing biomolecules, such as diagnostics for cancer and infectious diseases¹²⁻²⁴. Such sensors circumvent the need for fluorescence/radio-active tagging or enzymatic detection, and enable compact, simple, inexpensive, point-of-care diagnostics. Various sensing platforms based on optical¹²⁻¹⁷, electrical^{22,23}, and mechanical¹⁸⁻²¹ signal transduction mechanisms have been offered for applications ranging from laboratory research, to clinical diagnostics and drug development, to combating bioterrorism. Among these sensing platforms, optical detection platforms are particularly promising. Ideally, optical biosensors allow remote transduction of the biomolecular binding signal from the sensing volume without any physical connection between the excitation source and the detection channel^{25,26}. Unlike mechanical and electrical sensors, they are also compatible with physiological solutions, and are not sensitive to the changes in the ionic strengths of the solutions^{27,28}. However, a drawback of the most currently-used optical biosensors is that they require precise alignment of sensitive light coupling to the biodetection volume^{15-17,24}. As a result these technologies are not particularly suitable for point-of-care type applications.

Nanoplasmonic biosensors are distinctive among photonic sensors as they allow direct coupling of the perpendicularly incident light and constitute a robust sensing platform minimizing the alignment requirements for light coupling ^{12-14,29-32}. This capability also allows massive multiplexing in a ready manner²⁹. In addition, the extraordinary transmission (EOT) signals in plasmonic nanohole arrays create an excellent detection window enabling spectral measurements with minimal background noise and high signal-to-noise ratios³³⁻³⁵. Demonstrated herein are novel approaches combining optofluidics and nanoplasmonic sensing in a single platform enabling both the resonant transmission of light and the active transport of fluidics through them³⁵. With the newly developed optofluidic and nanoplasmonic biosensors, higher sensitivities and faster sensor response times were achieved as a result of lift-off free nanofabrication techniques in combination with the targeted analyte delivery scheme to the sensing surface³⁵⁻³⁷.

According to one aspect of the invention, an optofluidic nanoplasmonic sensor is disclosed comprising an upper chamber, where the upper chamber comprises a fluid inlet; a lower chamber, where the lower chamber comprises a fluid outlet; and a photonic crystal sensor between the upper chamber and the lower chamber, the photonic crystal sensor comprising a plurality of nanoholes, where an analyte is configured to flow from the first inlet, through the nanoholes in the photonic crystal sensor and to the fluid outlet.

In some embodiments, the upper chamber includes a glass surface, and the lower chamber includes a glass surface, and the sensor can, in some embodiments, also include a light source to direct light through one of the glass surfaces and a light detector to detect the light through the other one of the glass surfaces.

The sensor can also include a housing, the upper chamber lower chamber and photonic crystal sensor in the housing, where the housing comprises polydimethylsiloxane (PDMS).

According to another aspect of the invention, a method of making a sensor, such as a biosensor, is provided herein that includes depositing a silicon nitride film on a wafer; removing at least a portion of the silicon nitride film to form silicon nitride membranes; depositing positive e-beam resist over the wafer; performing e-beam lithography to transfer a nanohole pattern to the silicon nitride film through a dry etching process; and depositing at least one metal layer over the wafer.

In some embodiments, the wafer is silicon.

In some embodiments, the silicon nitride is deposited using Low Pressure Chemical Vapor Deposition (LPCVD).

In some embodiments, the at least a portion of the silicon nitride film can be removed using optical lithography, and one or more of dry and wet etching.

In some embodiments, the positive e-beam resist includes PMMA.

In some embodiments, the positive e-beam resist is removed using an oxygen plasma cleaning process.

In some embodiments, the depositing the at least one metal layer includes depositing a Ti metal layer and an Au metal layer.

In some embodiments, the at least one metal layer can define suspended plasmonic sensors in the nanohole openings.

According to another aspect of the invention, a method of making a biosensor is described herein that includes depositing a positive e-beam resist over a substrate; and performing e-beam lithography to form an array of nanoholes in the substrate.

In some embodiments, the method also comprises depositing at least one metal layer over the substrate.

According to another aspect of the invention, a sensor is disclosed that comprises a light source to generate light; a sensing structure comprising a first chamber, the first chamber comprising a fluid inlet, a second chamber, the second chamber comprising a fluid outlet, and a photonic crystal sensor between the first chamber and the second chamber, the photonic crystal sensor comprising a plurality of nanoholes, wherein an analyte is configured to flow from the first inlet, through the nanoholes in the photonic crystal sensor and to the fluid outlet, the photonic crystal sensor to change the refractive index of the light when the analyte flows through the nanoholes; and a detector to detect the changes to the refractive index.

In some embodiments, the upper chamber further comprises a glass surface, the lower chamber further comprises a glass surface and can further comprise a light source to direct light through one of the glass surfaces and a light detector to detect the light through the other one of the glass surfaces.

In some embodiments, the sensor further comprises a housing, the upper chamber lower chamber and photonic crystal sensor in the housing, and the housing can be polydimethylsiloxane (PDMS).

Another aspect of the invention provides nanoplasmonic biosensor arrays comprising a substrate and a metal film disposed upon the substrate. In such aspects, the metal film comprises one or more surfaces comprising an array of nanoelements arranged in a pattern, the nanoelements have a dimension less than one wavelength of an incident optical source to which the metal film produces surface plasmons, and the metal film is activated with an activating agent. In some embodiments of this aspect, the pattern of nanoelements is a periodic pattern. In some embodiments of this aspect, the pattern of nanoelements is a non-periodic pattern, such as a pseudo-random pattern or a random pattern.

In some embodiments of the aspect, the substrate comprises silicon dioxide, silicon nitride, glass, quartz, MgF₂, CaF₂, or a polymer.

In some embodiments of the aspect, the metal film produces surface plasmons to incident light in the UV-VIS-IR spectral range.

In some embodiments of the aspect, the metal is a Noble metal. In some embodiments of the aspect, the metal is selected from the group consisting of gold, rhodium, palladium, silver, osmium, iridium, platinum, titanium, and aluminum.

In some embodiments of the aspect, the metal film is between 50-500 nm thick. In some embodiments of the aspect, the metal film is between 75-200 nm thick.

In some embodiments of the aspect, the nanoelement is a nanohole. In some embodiments of the aspect, at least one dimension of the nanohole is between 10-1000 nm. In some embodiments of the aspect, at least one dimension of the nanohole is between 50-300 nm.

In some embodiments of the aspect, the nanoelements are separated by a periodicity of between 100-1000 nm. In some embodiments of the aspect, the nanoelements are separated by a periodicity of between 400-800 nm.

In some embodiments of the aspect, the activating agent is a piranha solution.

In some embodiments of the aspect, the nanoplasmonic biosensor array further comprises an adhesion layer between the metal film and the substrate. In some embodiments of the aspect, the adhesion layer comprises titanium or chromium. In some embodiments of the aspect, the adhesion layer is less than 50 nm. In some embodiments of the aspect, the adhesion layer is less than 25 nm. In some embodiments of the aspect, the adhesion layer is less than 15 nm.

In some embodiments of the aspect, the activated metal film is further functionalized with one or more capture agents. In some embodiments of the aspect, the capture agent is an antibody or antibody fragment thereof, a receptor, a recombinant fusion protein, or a nucleic acid molecule. In some embodiments of the aspect, the one or more capture agents comprise a first capture agent and a second capture agent, wherein the first capture agent is specific for the second capture agent, and the second capture agent is specific for one or more biomolecular targets. In some embodiments of the aspect, the first capture agent is protein A/G. In some embodiments of the aspect, the second capture agent comprises one or more antibodies or antibody fragments thereof.

Another aspect of the invention provides a nanoplasmonic biosensor system for detecting one or more biomolecular targets comprising: (i) a nanoplasmonic biosensor array as described herein; (ii) a device or a system for contacting one or more samples comprising one or more biomolecular targets to the metal film surface(s) of the nanoplasmonic biosensor array; (iii) an incident light source for illuminating a surface of the metal film to produce the surface plasmons; and (iv) an optical detection system for collecting and measuring light displaced from the illuminated metal film, wherein the displaced light is indicative of surface plasmon resonance on one or more surfaces of the metal film.

Another aspect provides a method for detecting one or more biomolecular targets comprising:
(i) providing a nanoplasmonic biosensor system as described herein;
(ii) contacting one or more samples comprising one or more biomolecular targets to the metal film surface of the nanoplasmonic biosensor array;
(iii) illuminating one or more surfaces of the metal film of the nanoplasmonic biosensor array with the incident light source to produce surface plasmons, before and after the contacting with the one or more samples;
(iv) collecting and measuring light displaced from the illuminated film with the optical detection system, before and after the contacting with the one or more samples; and
(v) detecting the one or more biomolecular targets based on a change or difference in the measurement of the light displaced from the illuminated film before and after the contacting with the one or more samples.

In some embodiments of the aspect, the biomolecular target is a eukaryotic cell, a eukaryotic cellular component, a prokaryote, a viral particle, a protein, and an oligonucleotide.

In some embodiments of the aspect, the collected light comprises light in a transmission mode, in a reflection mode, or a combination thereof.

In some embodiments of the aspect, the step of measuring displaced light comprises measuring light over a spectral range selected to comprise at least one plasmon band.

In some embodiments of the aspect, the change in the measurement of the displaced light before and after the contacting is a resonance peak shift, a change in a resonance peak intensity, a broadening of a resonance peak, a distortion in resonance of peak, or a change in refractive index.

### DEFINITIONS

For convenience, certain terms employed herein, in the specification, examples and appended claims are collected here. Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs.

“Surface plasmon resonance” refers to the physical phenomenon in which incident light is converted strongly into electron currents at the metal surface for planar surfaces, and “localized surface plasmon resonance (LSPR)” can also be used for surface plasmon resonance of nanometer-sized metallic structures. The oscillating currents produce strong electric fields in the (non-conducting) ambient medium near the surface of the metal. The electric fields, in turn, induce electric polarization in the ambient medium. Electric polarization is well known to cause the emission of light at wavelengths characteristic of the medium, i.e., the “Raman wavelengths.” Additional background information regarding this phenomenon may be found in Surface Enhanced Raman Scattering, ed. Chang & Furtak, Plenum Press, NY (1982), the entire disclosure of which is incorporated herein by reference. As used herein, the term “Raman scattering” is intended to encompass all related physical phenomena where an optical wave interacts with the polarizability of the material, such as Brillouin scattering or polariton scattering.

As used herein, “surface plasmons,” “surface plasmon polaritons,” or “plasmons” refer to the collective oscillations of free electrons at plasmonic surfaces, such as metals. These oscillations result in self-sustaining, surface electromagnetic waves, that propagate in a direction parallel to the metal/dielectric (or metal/vacuum) interface. Since the wave is on the boundary of the metal and the external medium (air or water for example), these oscillations are very sensitive to any change of this boundary, such as the adsorption of a biomolecular target to the metal surface. Subsequently, the oscillating electrons radiate electromagnetic radiation with the same frequency as the oscillating electrons. It is this re-radiation of light at the same incident wavelength that is referred to as “plasmon scatter.” These oscillations can also give rise to the intense colors of solutions of plasmon resonance nanoparticles and/or intense scattering. In the case of metallic nanoparticles, excitation by light results in localized collective electron charge oscillations, i.e., localized surface plasmon polaritions (LSPRs). They exhibit enhanced near-field amplitude at the resonance wavelength. This field is highly localized at the nanoparticle and decays rapidly away from the nanoparticle/dieletric interface into the dielectric background, though far-field scattering by the particle can also enhanced by the resonance. LSPR has very high spatial resolution at a subwavelength level, and is determined by the size of nanoparticles. “Plasmon absorption,” as used herein, refers to the extinction of light (by absorption and scattering) caused by metal surface plasmons.

As used herein, a “plasmonic material” refers to a material that exhibits surface plasmon resonance when excited with electromagnetic energy, such as light waves, even though the wavelength of the light is much larger than the particle. In some embodiments of the aspects described herein, plasmonic materials refer to metallic plasmonic materials. Such metallic plasmonic materials can be any metal, including noble metals, and alloys. Preferred plasmonic materials include, but are not limited to, gold, rhodium, palladium, silver, platinum, osmium, iridium, titanium, aluminum, copper, lithium, sodium, potassium, and nickel. A plasmonic material can be “optically observable” when it exhibits significant scattering intensity in the optical region (ultraviolet-visible-infrared spectra), which includes wavelengths from approximately 100 nanometers (nm) to 3000 nm. A plasmonic material can be “visually observable” when it exhibits significant scattering intensity in the wavelength band from approximately 380 nm to 750 nm, which is detectable by the human eye, i.e., the visible spectrum.

As used herein, the term “nanoplasmonic structure” refers to any independent structure, device, or system exhibiting surface plasmon resonance or localized surface plasmon resonance properties due to the presence, combination, or association of one or more nanoplasmonic elements, such as a nanoparticle or nanohole, as those terms are defined herein. For example, an array of nanoparticles or nanoholes is a nanoplasmonic structure. The nanoplasmonic elements can be arranged in any pattern that gives rise to a desired optical property for the nanostructure, such as periodic pattern or a non-periodic pattern, including pseudo-random and random patterns.

In some embodiments of the aspects described herein, a nanoplasmonic structure can comprise a “photonic crystal.” As used herein, a “photonic crystal” refers to a substance or material composed of periodic dielectric or metallo-dielectric nanoelements that affect the propagation of electromagnetic waves (EM). Essentially, photonic crystals contain regularly repeating internal regions of high and low dielectric constant. Photons (behaving as waves) propagate through this structure—or not—depending on their wavelength. Wavelengths of light that are allowed to travel are known as modes, and groups of allowed modes form bands. Disallowed bands of wavelengths are called photonic band gaps. This gives rise to distinct optical phenomena. The periodicity of the photonic crystal structure has to be of the same length-scale as half the wavelength of an incident EM wave, i.e., the repeating regions of high and low dielectric constants have to be of this dimension. Accordingly, in some embodiments, a photonic crystal can be used in a biosensor device.

The term “nanoplasmonic element,” as used herein, refers to an individual, microscopic unit of a plasmonic material that exhibits surface plasmon resonance properties, having at least one dimension in the approximately 1-3000 nm range, for example, in the range of about 1-2500 nm, in the range of about 1-2000 nm, in the range of about 1-1500 nm, in the range of about 1-1000 nm, in the range of about 10 nm to about 1000 nm, in the range of about 10 nm to about 750 nm, in the range of about 10 nm to about 500 nm, in the range of about 10 nm to about 250 nm, in the range of about 10 nm to about 100 nm, in the range of about 2 nm to about 100 nm, or in the range of about 2 nm to about 100 nm. Such a unit of plasmonic material can be in the form of a nanoparticle, and present on or embedded within the surface of a substance or substrate, or can be in the form of a nanohole and present as an aperture within a plasmonic material, such as a metal film.

A “nanoparticle,” as described herein, refers to a nanoplasmonic element having one dimension of about 300 nm or less, about 250 nm or less, about 240 nm or less, about 230 nm or less, about 220 nm or less, about 210 nm or less, about 200 nm or less, about 190 nm or less, about 180 nm or less, about 170 nm or less, about 160 nm or less, about 150 nm or less, about 140 nm or less, about 130 nm or less, about 120 nm or less, about 110 nm or less, about 100 nm or less, about 90 nm or less, about 80 nm or less, about 70 nm or less, about 60 nm or less, about 50 nm or less, about 40 nm or less, about 30 nm or less, about 20 nm or less, or about 10 nm or less; and a second dimension of about 1500 nm or less, about 1400 nm or less, about 1300 nm or less, about 1200 nm or less, about 1100 nm or less, about 1000 nm or less, about 900 nm or less, about 800 nm or less, about 700 nm or less, about 600 nm or less, or about 500 nm or less. The nanoparticles of the present invention have a preselected shape and can be a nanotube, a nanowires, nanosphere, or any shape comprising the above-described dimensions (e.g., triangular, square, rectangular, or polygonal shape in 2 dimensions, or cuboid, pyramidal, spherical, discoid, or hemispheric shapes in the 3 dimensions).

A “nanohole” as used herein refers to an opening or aperture in a plasmonic material, such as a metal film, preferably a sub-wavelength opening, such as a hole, a gap or slit, that causes or enhances the surface plasmon resonance properties of the plasmonic material in which it is present. As used herein, nanoholes include symmetric circular holes, spatially anistropic shapes, e.g., elliptical shapes, slits, and also include any aperture of a triangular, square, rectangular, or polygonal shape. In some embodiments, a combination of different shaped nanoholes may be used. In addition, nanoholes can be through nanoholes that penetrate through a plasmonic material, such as a metal film, or non-through nanoholes that penetrate a part of a plasmonic material without completely penetrating through the plasmonic material. Preferably, a nanohole has a dimension of about 1500 nm or less, about 1400 nm or less, about 1300 nm or less, about 1200 nm or less, about 1100 nm or less, about 1000 nm or less, about 900 nm or less, about 800 nm or less, about 700 nm or less, about 600 nm or less, about 500 nm or less, about 450 nm or less, about 400 nm or less, about 350 nm or less about 300 nm or less, about 250 nm or less, about 240 nm or less, about 230 nm or less, about 220 nm or less, about 210 nm or less, about 200 nm or less, about 190 nm or less, about 180 nm or less, about 170 nm or less, about 160 nm or less, about 150 nm or less, about 140 nm or less, about 130 nm or less, about 120 nm or less, about 110 nm or less, about 100 nm or less, about 90 nm or less, about 80 nm or less, about 70 nm or less, about 60 nm or less, about 50 nm or less, about 40 nm or less, about 30 nm or less, about 20 nm or less, or about 10 nm or less.

As used herein, the term “resist” refers to both a thin layer used to transfer an image or [circuit] pattern, such as a circuit pattern, to a substrate which it is deposited upon. A resist can be patterned via lithography to form a (sub)micrometer-scale, temporary mask that protects selected areas of the underlying substrate during subsequent processing steps, typically etching. The material used to prepare the thin layer (typically a viscous solution) is also encompassed by the term resist. Resists are generally mixtures of a polymer or its precursor and other small molecules (e.g., photoacid generators) that have been specially formulated for a given lithography technology. Resists used during photolithography, for example, are called photoresists.

As used herein, “resist deposition” refers to the process whereby a precursor solution is spin-coated on a clean (e.g., semiconductor) substrate, such as a silicon wafer, to form a very thin, uniform layer. The layer is baked at a low temperature to evaporate residual solvent, which is known as “soft bake.” This is followed by the “exposure” step, whereby a latent image is formed in the resist, e.g., (a) via exposure to ultraviolet light through a photomask with opaque and transparent regions or (b) by direct writing using a laser beam or electron beam. Areas of the resist that have (or have not) been exposed are removed by rinsing with an appropriate solvent during the development step. This step is followed by the post-exposure bake step, which is followed by a step of processing through the resist pattern using, for example, wet or dry etching, lift-off, doping. The resist deposition process is then ended via resist stripping.

As used herein, the process known as “lift-off” refers to the removal of residue of functional material adsorbed on the mask or stencil along with the template itself during template removal by, for example, dissolving it in a solvent solution.

As defined herein, a “biomolecular target” refers to a biological material such as a protein, an oligonucleotide (RNA, DNA), a cell (prokaryotic, eukaryotic), and a virus particle. Other types of biomolecular targets which can be detected by the nanoplasmonic sensors described herein include low molecular weight molecules (i.e., substances of molecular weight <1000 Daltons (Da) and between 1000 Da to 10,000 Da), and include amino acids, nucleic acids, lipids, carbohydrates, nucleic acid polymers, viral particles, viral components and cellular components. Cellular components that can serve as biomolecular targets can include, but are not limited to, vesicles, mitochondria, membranes, structural features, periplasm, or any extracts thereof.

As used herein, the terms “sample,” “biological sample” or “analyte” means any sample comprising or being tested for the presence of one or more biomolecular targets, including, but not limited to cells, organisms (bacteria, viruses), lysed cells or organisms, cellular extracts, nuclear extracts, components of cells or organisms, extracellular fluid, media in which cells or organisms are cultured, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears and prostatic fluid. In addition, a sample can be a viral or bacterial sample, a sample obtained from an environmental source, such as a body of polluted water, an air sample, or a soil sample, as well as a food industry sample.

“Tissue” is defined herein as a group of cells, often of mixed types and usually held together by extracellular matrix, that perform a particular function. Also, in a more general sense, “tissue” can refer to the biological grouping of a cell type result from a common factor; for example, connective tissue, where the common feature is the function or epithelial tissue, where the common factor is the pattern of organization.

As used herein, a “capture agent” refers to any agent having specific binding for a biomolecular target that can be immobilized on the surface of a nanoplasmonic structure, including, but not limited to, a nucleic acid, oligonucleotide, peptide, polypeptide, antigen, polyclonal antibody, monoclonal antibody, single chain antibody (scFv), F(ab) fragment, F(ab′)₂ fragment, Fv fragment, small organic molecule, polymer, compounds from a combinatorial chemical library, inorganic molecule, or any combination thereof.

A “nucleic acid”, as described herein, can be RNA or DNA, and can be single or double stranded, and can be, for example, a nucleic acid encoding a protein of interest, a polynucleotide, an oligonucleotide, a nucleic acid analogue, for example peptide-nucleic acid (PNA), pseudo-complementary PNA (pc-PNA), locked nucleic acid (LNA) etc. Such nucleic acid sequences include, for example, but are not limited to, nucleic acid sequence encoding proteins, for example that act as transcriptional repressors, antisense molecules, ribozymes, small inhibitory nucleic acid sequences, for example, but not limited to, RNAi, shRNAi, siRNA, micro RNAi (mRNAi), antisense oligonucleotides etc.

As used herein, the term “DNA” is defined as deoxyribonucleic acid. The term “polynucleotide” is used herein interchangeably with “nucleic acid” to indicate a polymer of nucleosides. Typically a polynucleotide of this invention is composed of nucleosides that are naturally found in DNA or RNA (e.g., adenosine, thymidine, guanosine, cytidine, uridine, deoxyadenosine, deoxythymidine, deoxyguanosine, and deoxycytidine) joined by phosphodiester bonds. However the term encompasses molecules comprising nucleosides or nucleoside analogs containing chemically or biologically modified bases, modified backbones, etc., whether or not found in naturally occurring nucleic acids, and such molecules may be preferred for certain applications. As used herein, a polynucleotide is understood to include both DNA, RNA, and in each case both single- and double-stranded forms (and complements of each single-stranded molecule). “Polynucleotide sequence” as used herein can refer to the polynucleotide material itself and/or to the sequence information (i.e., the succession of letters used as abbreviations for bases) that biochemically characterizes a specific nucleic acid. A polynucleotide sequence presented herein is presented in a 5′ to 3′ direction unless otherwise indicated.

The term “polypeptide” as used herein refers to a polymer of amino acids. The terms “protein” and “polypeptide” are used interchangeably herein. A peptide is a relatively short polypeptide, typically between about 2 and 60 amino acids in length. Polypeptides used herein typically contain amino acids such as the 20 L-amino acids that are most commonly found in proteins. However, other amino acids and/or amino acid analogs known in the art can be used. One or more of the amino acids in a polypeptide may be modified, for example, by the addition of a chemical entity such as a carbohydrate group, a phosphate group, a fatty acid group, a linker for conjugation, functionalization, etc. A polypeptide that has a nonpolypeptide moiety covalently or noncovalently associated therewith is still considered a “polypeptide.” Exemplary modifications include glycosylation and palmitoylation. Polypeptides may be purified from natural sources, produced using recombinant DNA technology, synthesized through chemical means such as conventional solid phase peptide synthesis, etc. The terms “polypeptide sequence” or “amino acid sequence” as used herein can refer to the polypeptide material itself and/or to the sequence information (i.e., the succession of letters or three letter codes used as abbreviations for amino acid names) that biochemically characterizes a polypeptide. A polypeptide sequence presented herein is presented in an N-terminal to C-terminal direction unless otherwise indicated.

“Receptor” is defined herein as a membrane-bound or membrane-enclosed molecule that binds to, or responds to something more mobile (the ligand), with high specificity.

“Ligand” is defined herein as a molecule that binds to another; in normal usage a soluble molecule, such as a hormone or neurotransmitter, that binds to a receptor. Also analogous to “binding substance” herein.

“Antigen” is defined herein as a substance inducing an immune response. The antigenic determinant group is termed an epitope, and the epitope in the context of a carrier molecule (that can optionally be part of the same molecule, for example, botulism neurotoxin A, a single molecule, has three different epitopes. See Mullaney et al., Infect Immun October 2001; 69(10): 6511-4) makes the carrier molecule active as an antigen. Usually antigens are foreign to the animal in which they produce immune reactions.

As used herein, “antibodies” can include polyclonal and monoclonal antibodies and antigen-binding derivatives or fragments thereof. Well-known antigen binding fragments include, for example, single domain antibodies (dAbs; which consist essentially of single VL or VH antibody domains), Fv fragment, including single chain Fv fragment (scFv), Fab fragment, and F(ab′)₂ fragment. Methods for the construction of such antibody molecules are well known in the art. As used herein, the term “antibody” refers to an intact immunoglobulin or to a monoclonal or polyclonal antigen-binding fragment with the Fc (crystallizable fragment) region or FcRn binding fragment of the Fc region. Antigen-binding fragments can be produced by recombinant DNA techniques or by enzymatic or chemical cleavage of intact antibodies. “Antigen-binding fragments” include, inter alia, Fab, Fab′, F(ab′)2, Fv, dAb, and complementarity determining region (CDR) fragments, single-chain antibodies (scFv), single domain antibodies, chimeric antibodies, diabodies and polypeptides that contain at least a portion of an immunoglobulin that is sufficient to confer specific antigen binding to the polypeptide. The terms Fab, Fc, pFc′, F(ab′)2 and Fv are employed with standard immunological meanings [Klein, Immunology (John Wiley, New York, N.Y., 1982); Clark, W. R. (1986) The Experimental Foundations of Modern Immunology (Wiley & Sons, Inc., New York); Roitt, I. (1991) Essential Immunology, 7th Ed., (Blackwell Scientific Publications, Oxford)].

“Polyclonal antibody” is defined herein as an antibody produced by several clones of B-lymphocytes as would be the case in a whole animal, and usually refers to antibodies raised in immunized animals. “Monoclonal antibody” is defined herein as a cell line, whether within the body or in culture, that has a single clonal origin. Monoclonal antibodies are produced by a single clone of hybridoma cells, and are therefore a single species of antibody molecule. “Single chain antibody (Scfv)” is defined herein as a recombinant fusion protein wherein the two antigen binding regions of the light and heavy chains (Vh and Vl) are connected by a linking peptide, which enables the equal expression of both the light and heavy chains in a heterologous organism and stabilizes the protein. “F(Ab) fragment” is defined herein as fragments of immunoglobulin prepared by papain treatment. Fab fragments consist of one light chain linked through a disulphide bond to a portion of the heavy chain, and contain one antigen binding site. They can be considered as univalent antibodies. “F(Ab′)₂ Fragment” is defined herein as the approximately 90 kDa protein fragment obtained upon pepsin hydrolysis of an immunoglobulin molecule N-terminal to the site of the pepsin attack. Contains both Fab fragments held together by disulfide bonds in a short section of the Fe fragment. “Fv Fragment” is defined herein as the N-terminal portion of a Fab fragment of an immunoglobulin molecule, consisting of the variable portions of one light chain and one heavy chain.

As used herein, the term “small molecule” refers to a chemical agent including, but not limited to, peptides, peptidomimetics, amino acids, amino acid analogs, polynucleotides, polynucleotide analogs, aptamers, nucleotides, nucleotide analogs, organic or inorganic compounds (i.e., including heteroorganic and organometallic compounds) having a molecular weight less than about 10,000 grams per mole, organic or inorganic compounds having a molecular weight less than about 5,000 grams per mole, organic or inorganic compounds having a molecular weight less than about 1,000 grams per mole, organic or inorganic compounds having a molecular weight less than about 500 grams per mole, and salts, esters, and other pharmaceutically acceptable forms of such compounds.

As used herein, the term “drug” or “compound” refers to a chemical entity or biological product, or combination of chemical entities or biological products, administered to a person to treat or prevent or control a disease or condition. The chemical entity or biological product is preferably, but not necessarily a low molecular weight compound, but may also be a larger compound, for example, an oligomer of nucleic acids, amino acids, or carbohydrates including, without limitation, proteins, oligonucleotides, ribozymes, DNAzymes, glycoproteins, siRNAs, lipoproteins, aptamers, and modifications and combinations thereof.

The terms “label” or “tag”, as used herein, refer to a composition capable of producing a detectable signal indicative of the presence of the target in an assay sample. Suitable labels include radioisotopes, nucleotide chromophores, enzymes, substrates, fluorescent molecules, chemiluminescent moieties, magnetic particles, bioluminescent moieties, and the like. As such, a label is any composition detectable by spectroscopic, photochemical, biochemical, immunochemical, electrical, optical or chemical means.

The articles “a” and “an” are used herein to refer to one or to more than one (i.e., at least one) of the grammatical object of the article. By way of example, “an element” means one element or more than one element. Thus, in this specification and the appended claims, the singular forms “a,” “an,” and “the” include plural references unless the context clearly dictates otherwise. Thus, for example, reference to a pharmaceutical composition comprising “an agent” includes reference to two or more agents.

As used herein, the term “comprising” means that other elements can also be present in addition to the defined elements presented. The use of “comprising” indicates inclusion rather than limitation. The term “consisting of” refers to compositions, methods, and respective components thereof as described herein, which are exclusive of any element not recited in that description of the embodiment. As used herein the term “consisting essentially of” refers to those elements required for a given embodiment. The term permits the presence of elements that do not materially affect the basic and novel or functional characteristic(s) of that embodiment of the invention. Other than in the operating examples, or where otherwise indicated, all numbers expressing quantities of ingredients or reaction conditions used herein should be understood as modified in all instances by the term “about.” The term “about” when used in connection with percentages can mean±1%.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and reagents, etc., described herein and as such can vary. The terminology used herein is for the purpose of describing particular embodiments only, and is not intended to limit the scope of the present invention, which is defined solely by the claims. Definitions of common terms in immunology, and molecular biology can be found in The Merck Manual of Diagnosis and Therapy, 18th Edition, published by Merck Research Laboratories, 2006 (ISBN 0-911910-18-2); Robert S. Porter et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8); Immunology by Werner Luttmann, published by Elsevier, 2006. Definitions of common terms in molecular biology are found in Benjamin Lewin, Genes IX, published by Jones & Bartlett Publishing, 2007 (ISBN-13: 9780763740634); Kendrew et al. (eds.), The Encyclopedia of Molecular Biology, published by Blackwell Science Ltd., 1994 (ISBN 0-632-02182-9); and Robert A. Meyers (ed.), Maniatis et al., Molecular Cloning: A Laboratory Manual, Cold Spring Harbor Laboratory Press, Cold Spring Harbor, N.Y., USA (1982); Sambrook et al., Molecular Cloning: A Laboratory Manual (2 ed.), Cold Spring Harbor Laboratory Press, Cold Spring Harbor, N.Y., USA (1989); Davis et al., Basic Methods in Molecular Biology, Elsevier Science Publishing, Inc., New York, USA (1986); or Methods in Enzymology: Guide to Molecular Cloning Techniques Vol. 152, S. L. Berger and A. R. Kimmerl Eds., Academic Press Inc., San Diego, USA (1987); Current Protocols in Molecular Biology (CPMB) (Fred M. Ausubel, et al. ed., John Wiley and Sons, Inc.), Current Protocols in Protein Science (CPPS) (John E. Coligan, et. al., ed., John Wiley and Sons, Inc.) and Current Protocols in Immunology (CPI) (John E. Coligan, et. al., ed. John Wiley and Sons, Inc.), which are all incorporated by reference herein in their entireties.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

This patent application file contains at least one drawing executed in color. Copies of this patent or patent application publication with color drawing(s) will be provided by the Patent Office upon request and payment of the necessary fee.

FIGS. 1A-1D illustrate a biosensor according to one embodiment of the invention. Illustration of the actively controlled flow scheme is shown in FIG. 1A. The nanohole arrays are used as sensing structures as well as nanofluidic channels. This is contrary to the conventional approach in which the convective flow stream passes over the sensor (FIG. 1B). FIGS. 1C and 1D show steady state velocity distribution for the actively (FIG. 1A) and the passively (FIG. 1B) controlled convective flow schemes.

FIGS. 2A-2D illustrate a method of making the biosensor according to one embodiment of the invention using a lift-off free fabrication process 200. E-beam lithography is shown in FIG. 2A. A nanohole pattern (with hole diameters of approximately 220 nm and a periodicity of approximately 600 nm) is transferred to the suspended SiNx film through a dry etching process. The e-beam resist is then removed with an oxygen plasma cleaning process leaving only a patterned SiNx film with air on both sides. Only a small shrinking in nanohole diameter (<4%) is observed after gold deposition due to slight coverage of the metal layers on the nanohole sidewalls, as shown in FIGS. 2B-2D.

FIGS. 3A-3B demonstrate experimental implementation of a sensor comprising square lattice SiNₓ PhC slabs. FIG. 3A shows the transmission spectra of a specific design calculated by three dimensional finite-difference time-domain (3D-FDTD) method in three different media: air (refractive index n=1), water (n=1.33), and an IPA-chloroform mixture (n=1.43). A normally incident plane wave source (corresponding to the □-point in the dispersion diagram) excites the eigenmodes of the system. For each case, two modes are observed within the given spectral range. FIG. 3B shows the intensity distribution of the lowest (first) order mode when the structure is in air.

FIGS. 4A-4D show video images of the perpendicular convective flow, captured in a microscope with a CCD camera. FIGS. 4A-4D show the merge of IPA to the top channel only through the openings, confirming the active steering of the liquid flow. No damage or breakage of the membrane due to the applied pressure is observed.

FIGS. 5A-5C show a comparison of transmitted spectra of PhCs to experimentally evaluate the sensing response of the different flow schemes by launching a collimated and unpolarized light at normal incidence.

FIGS. 6A-6B demonstrate testing of bulk sensitivity of PhCs by successively applying five different solutions through the directed flow scheme: DI-water, acetone, IPA and two IPA-chloroform mixtures with refractive indices of 1, 1.33, 1.356, 1.377, 1.401 and 1.424, respectively. As shown in FIG. 6A, with increasing refractive index the resonances red-shift and the line-widths become narrower. FIG. 6B shows shifts of the 1st resonant peaks in wavelength versus the surrounding refractive index change. Resonance peak positions found in experiments (blue stars) match very well with the simulation results (green circles). Red line is a linear fitting to the experimental results.

FIGS. 7A-7B compare a cross-polarization spectrum with a regular one. The spectra are taken when the structure is in air. Cross-polarization measurements clearly isolate two distinct resonance features from the background (FIG. 7A). A single Lorentzian with 7 nm line-width fits very well with the second order mode resonance (FIG. 7B). On the other hand, two Lorenztians are needed to fit the lowest order mode (FIG. 7B). This indicates a potential resonance splitting for the lowest order mode, which could be due to a slight non-uniformity in fabrication. The addition of three Lorentzians (red dashed curve in FIG. 7B) matches very well with the experimentally measured spectrum.

FIGS. 8A-8D show targeted delivery of analytes to a sensor surface. FIG. 8A shows bulk refractive index sensitivity of plasmonic nanohole arrays obtained in different solutions. FIG. 8B demonstrates resonance shifts for the passively and actively controlled mass transport schemes compared after running IPA (analyte) for 10 min at 20 μm/min flow rate. Microfluidic simulations demonstrate low transfer rates for the passive transport scheme due to the weaker perpendicular flow of the analytes (FIG. 8C), while FIG. 8D demonstrates much more efficient mass transport toward the surface observed for the targeted delivery scheme.

FIG. 9 demonstrates efficiencies of the passive (triangles) and targeted (squares) delivery of the analytes compared in real time measurements. A 14-fold improvement in mass transport rate constant is observed for the targeted delivery scheme.

FIGS. 10A-10D show 3-D renderings (not drawn to scale), and experimental measurements illustrating a detection scheme using optofluidic-plasmonic biosensors based on resonance transmissions due to extraordinary light transmission effect. FIG. 10A shows detection (immobilized with capturing antibody) and control sensors. FIG. 10B demonstrates that VSV only attaches to the antibody immobilized sensor. FIG. 10C demonstrates that no observable shift is detected for the control sensor after the VSV incubation and washing. FIG. 10D demonstrates accumulation of VSV due to capture by immobilized antibodies. A large effective refractive index increase results in strong red-shifting of the plasmonic resonances (˜100 nm).

FIGS. 11A-11F summarize a fabrication process. FIG. 11A shows free standing membranes spin coated with positive e-beam resist, and e-beam lithography performed. FIG. 11B shows that a nanohole pattern is transferred to a SiNx membrane through RIE processes. FIG. 11C shows that an oxygen cleaning process results in a free standing photonic crystal like structure. FIG. 11D demonstrates that metal deposition results in a free standing optofluidic-nanoplasmonic biosensor with no clogging of the holes. FIG. 11E shows scanning electron microscope images of patterned SiNx membranes before gold deposition. FIG. 11F demonstrates that gold deposition results in suspended plasmonic nanohole sensors without any lift-off process. No clogging of the nanohole openings is observed (inset).

FIGS. 12A-12B depict a representative immunosensor function. FIG. 12A shows a schematic of an immunosensor surface functionalization. Anti-viral immunoglobulins are attached from the Fc region to the surface through a protein A/G layer. FIG. 12B shows sequential functionalization of the bare sensing surface (dark line) for the optofluidic-nanohole sensors with a sensitivity of FOM0. Immobilization of the protein A/G (medium line) and viral antibody layer (light line to the right) results in the red shifting of the EPT resonance by 4 nm and 14 nm.

FIGS. 13A-13D demonstrate detection of PT-Ebola viruses and vaccinia viruses. Detection of PT-Ebola virus (FIG. 13A) and vaccinia viruses (FIG. 13C) are shown in spectral measurements at a concentration of 10⁸ PFU/ml. FIGS. 13B and 13D demonstrate repeatability of the measurements obtained from multiple sensors (dark). Minimal shifting due to non-specific bindings are observed in reference spots (light).

FIGS. 14A-14B demonstrate applicability of inventors' optofluidic nanoplasmonic detection platforms in biologically relevant systems shown by virus detection measurements performed in cell culturing media. FIG. 14A shows non-specific binding to control spots results in a 1.3 nm red-shifting of plasmonic resonances. Measurements are also obtained for control spots after each incubation process, although control sensor surfaces are not functionalized with protein A/G and antibody. FIG. 14B demonstrates that a resonance shift of 4 nm is observed for the detection of sensor resonance showing that the specific capturing of intact viruses at a low concentration of 10⁶ PH J/ml is clearly distinguishable at the antibody functionalized sensors.

### DETAILED DESCRIPTION

Described herein are label-free nanoplasmonic sensors, such as biosensors, and methods of use thereof for the targeting and detection of a variety of biomolecular targets. The sensing platforms described herein are based on the extraordinary light transmission effect in suspended plasmonic nanoholes. Also provided herein are sensing platforms or systems comprising a multilayered microfluidics scheme for contacting a sample to a nanoplasmonic sensor that allows three-dimensional control of fluidic flow by connecting layers of microfluidic channels through plasmonic nanoholes. This scheme is a hybrid biosensing system that merges nanoplasmonics and nanofluidics into a single sensing platform or system. The nanoholes of the nanoplasmonic sensors act as nanofluidic channels connecting the fluidic chambers on both sides of the sensors. Embodiments of the invention result in a 14-fold improvement in the mass transport rate constants. These improvements results in superior analyte delivery to the biosensor surface at low concentrations. Another exemplary advantageous feature is an extra degree of freedom in microfluidic circuit engineering by connecting separate layers of microfluidic circuits through biosensors. These approaches make it possible to create “multilayered lab-on-chip systems” allowing three dimensional control of the fluid flow.

To fabricate the nanostructures, a lift-off free plasmonic device fabrication technique based on positive resist electron beam lithography (EBL) can be used. The simplicity of this fabrication technique allows fabrication of nanostructures with extremely high yield/reproducibility and minimal surface roughness.

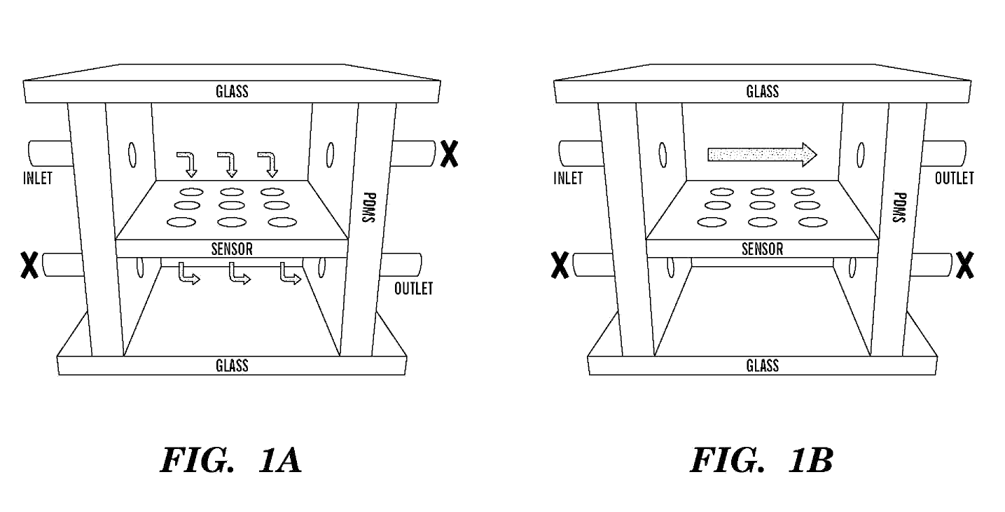

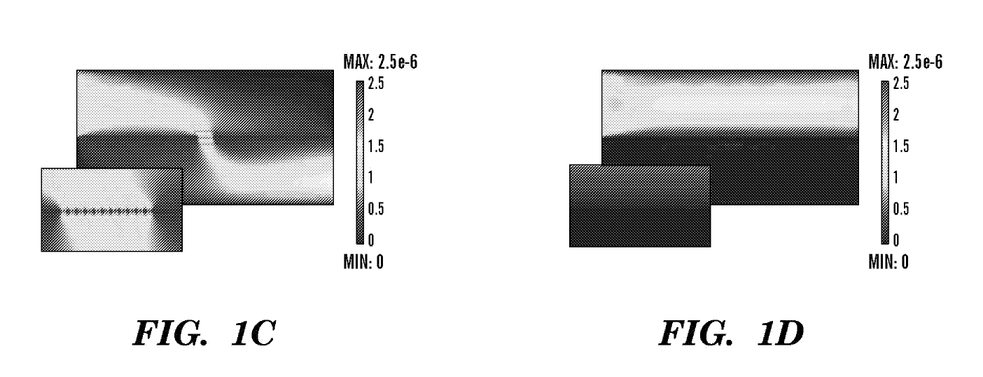

An aspect of the invention is described herein in detail with reference to FIGS. 1A and 1B. The free standing PhCs (photonic crystals) are sealed in a chamber such that only the nano-scale hole arrays enable the flow between the top and the bottom channels. Illustration of the actively controlled flow scheme is shown in FIG. 1A. Solution directed to the structure surface goes through the nanohole arrays and flows to the bottom channel. The nanohole arrays are used as sensing structures as well as nanofluidic channels. This is contrary to the conventional approach in which the convective flow stream passes over the sensor (FIG. 1B).

In some embodiments of the aspect, the housing of the sensing platform includes sidewalls made of polydimethylsiloxane (PDMS), an upper surface made of glass, and a lower surface made of glass. The sensing structure is suspended between the upper and lower glass surfaces. The housing also includes a fluid inlet/outlet in at least one of the chambers and at least one fluid inlet/outlet in the other one of the chambers. It will be appreciated that both of the chambers can include two or more fluid inlet/outlets. In this embodiment, valves, an air regulation system and one or more controllers can be used to control the flow in the sensing structure. Analytes that are delivered through the inlet flow of one chamber (upper chamber or lower chamber) over the sensing structure and through the nanoholes and leave the sensing structure through the outlet in the other chamber (lower chamber or upper chamber). This offers an extra degree of freedom in microfluidic circuit engineering by connecting separate layers of microfluidic circuits through biosensors.

It will be appreciated that, in some embodiments, a optical source is provided that generates light and directs it toward the sensing membrane (e.g., through the glass surface of the upper chamber). It will also be appreciated that a detector is also provided to sense the refractive changes in the sensing membrane.

In order to implement the proposed scheme, PhC structures are used on free standing membranes. In one embodiment, the membranes are mechanically robust Low Pressure Chemical Vapor Deposition (LPCVD) silicon nitride (SiNx) films. In addition, LPCVD SiNx films can be used, which are transparent in the visible/near-infrared regime with high refractive index. In some embodiments, the films can then be coated with one or more metals, such as titanium (Ti) or gold (Au).

The flow profile with the novel platform was compared to the flow profile with the conventional approach by numerically solving Navier-Stokes equations using finite element method in COMSOL™. The simulations are done in two-dimensions using incompressible isothermal fluid flow. In the model, two microfluidic channels (on top and bottom) with 200 μm in length and 50 μm in height were used. A row of ten rods spaced by 0.6 μm represents the nanohole arrays. The opening at the top left side of the microfluidic channel is used as the inlet to flow the solution (water) to the chamber at a velocity of 10⁻⁶ m/s. The openings at the bottom and the top right side with no pressure applied are used as an outlet for the actively controlled and the conventional fluidic flow schemes, respectively. The spacing between the rods is defined as continuous boundary which allows the solution to flow through, while the other boundaries are treated as no slip walls.

As illustrated in FIGS. 1A-1B, this multi-inlet/outlet fluidic platform allows for active control of the fluidic flow in three dimensions through the plasmonic nanohole openings. Convective flow over different surfaces of the plasmonic sensor is realized by running the solutions in between input-output lines on the same side, such as 1→2/3→4 (FIG. 1A). The convective flow in separate channels is nearly independent. In the actively controlled (targeted) delivery scheme, the convective flow is steered perpendicularly towards the plasmonic sensing surface by allowing the flow only through one inlet/outlet on either side of the plasmonic sensor (FIG. 1B). Flow could be directed from top-to-down and down-to-top directions by enabling flow between 1→4 and 3→2, respectively.

FIGS. 1C and 1D show steady state velocity distribution for the actively (FIG. 1A) and the passively (FIG. 1B) controlled convective flow schemes. Flow profiles around PhC regions are shown in detail (insets). For the passively controlled scheme (FIG. 1D), as the viscous forces in the fluid dominate over the inertial forces, we observe the formation of laminar flow profile. The convective flow is fast close to the center of the channel but becomes very slow near the edges. This indicates that in an immunoassay based sensing applications, as described herein, the depletion zones will extend further from the sensor surface causing ever slower analyte transport for detection of a biomolecular target. One can increase the convective flow rate to shrink the depletion zones. However, such a passive (indirect) control only results in moderate improvements in mass transport rates. One alternative approach according to the illustrated embodiment of FIG. 1A overcomes the mass transport limitation by steering the convective flow directly towards the sensing surface. This is demonstrated in microfludic simulation in FIG. 1C where the convective flow is still very strong around the sensing surface and the turbulences (stirring of the solution) are generated around the holes. Such a directed flow can strongly improve the delivery of the analytes or samples to the sensor surface. This scheme also helps to overcome the surface tension of highly viscous solution and guarantees that the sensor can be totally immersed in solution. In this way, as both sides of the structure are exposed to the solution, the sensitivity is further enhanced. The nanofluidic channels also create turbulences and stir the solution as it passes through the sensing structure, further increasing the mass transport.

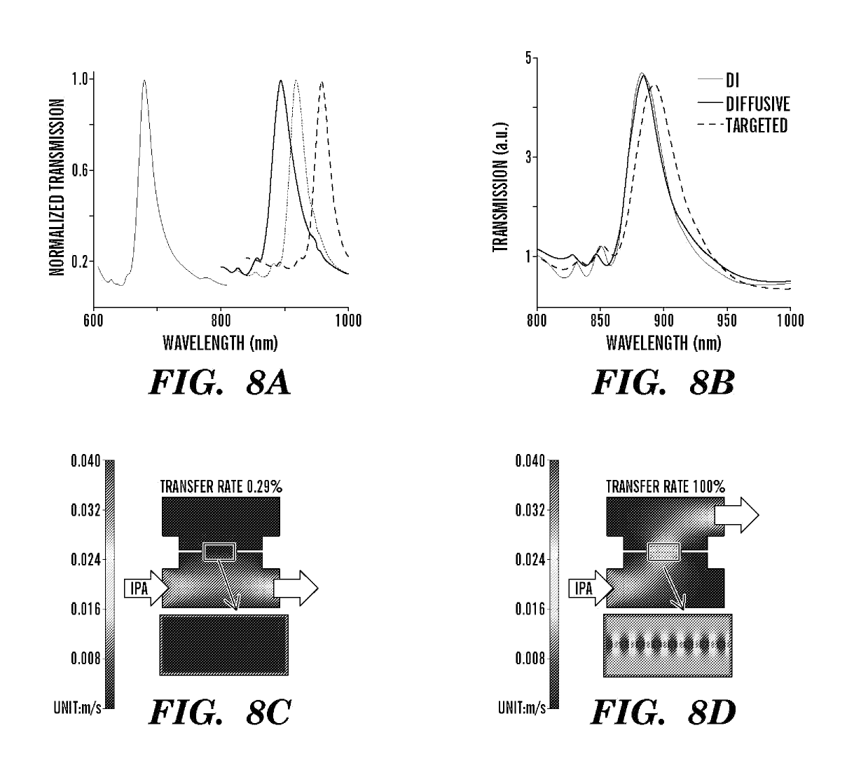

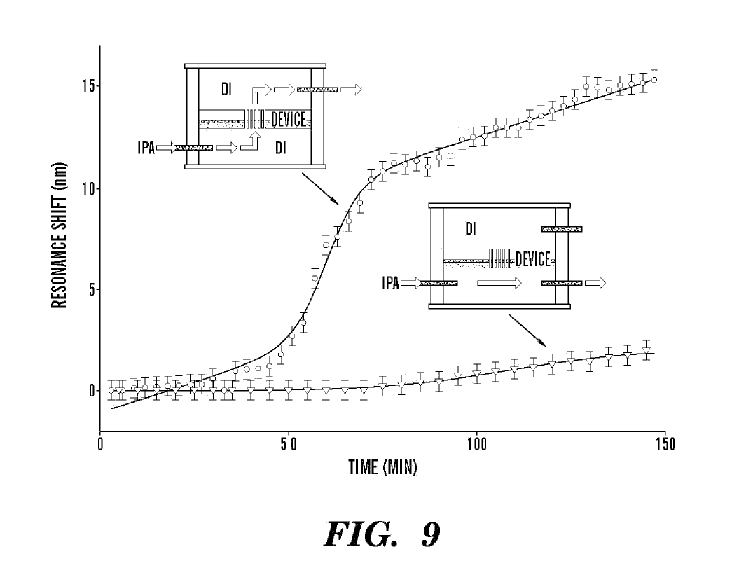

Targeted delivery of analytes to the sensing surface has been demonstrated using spectral measurements as shown in FIG. 8. Initially, both the top and the bottom channels are filled with a low refractive index liquid, deionized (DI) water (n_{DI}=1.333), at a high flow rate (550 μL/min). Once the channels are filled with DI water completely, the plasmonic resonance shifts from λₐᵢₜ=679 nm (air on both sides) to λ_{DI}=889 nm (DI on both sides). This corresponds to a bulk refractive index sensitivity of Δλ/Δn=630 nm/RIU. As plasmons at the Ti/SiN interface are suppressed by the losses, this shift only reflects the response of the plasmons on the gold surface to the changing refractive index in the top channel.

The spectrum obtained once the channels are filled with DI-water is used as a background for further measurements. To quantify the analyte transport efficiency of both delivery schemes, a lower viscosity analyte solution (IPA) with higher refractive index was introduced from the bottom inlet. The plasmonic sensor responses only to the refractive index change due to the perpendicularly diffused or actively delivered IPA solution depend on the scheme. In the diffusive transport scheme, IPA solution is pumped into the bottom channel and collected from the bottom side at a flow rate of 20 μL/min (top outlet is kept open). For targeted delivery of the convective current to the surface, IPA can be directed from a down-to-top direction by enabling flow between 3→2. In this case, a much larger red shifting (Δλ=10 nm) of the plasmonic resonance from DI-water background is obtained after flowing IPA solution for 10 min at the same flow rate (20 μL/min). This clearly shows that the targeted delivery scheme in the nanoplasmonic-nanofluidic platform of the invention transports the analyte to the sensor surface more efficiently and improve the sensor performance.

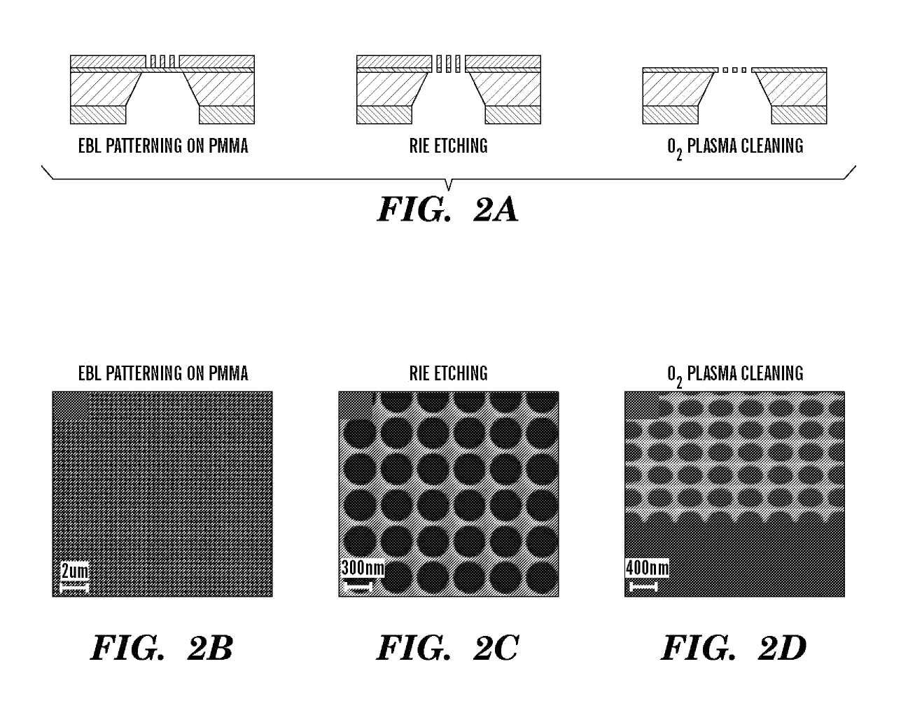

A lift-off free fabrication process 200, according to one aspect of the invention, is illustrated in FIGS. 2A-2D. The fabrication process 200 is based on single layer e-beam lithography and reactive ion etching (RIE). It will be appreciated that the process can include fewer or additional steps.

The fabrication process 200 begins by coating a silicon wafer with a Low Pressure Chemical Vapor Deposition (LPCVD) silicon nitride (SiNx) film. The process continues by forming free standing SiNx membranes (approximately 50 nm thick) using optical lithography and dry/wet etching methods. The membranes are then covered with positive e-beam resist (PMMA). E-beam lithography is then performed, as shown FIG. 2A. A nanohole pattern (with hole diameters of approximately 220 nm and a periodicity of approximately 600 nm) is transferred to the suspended SiNx film through a dry etching process. The e-beam resist is then removed with an oxygen plasma cleaning process leaving only a patterned SiNx film with air on both sides. A directional e-beam metal deposition tool may be used to deposit Ti (5 nm) and Au (125 nm) metal layers defining the suspended plasmonic sensors with nanohole openings. This deposition process is advantageous because it is extremely reliable—large areas of nanoholes covered with gold are repeatedly obtained without clogging the openings. Only a small shrinking in nanohole diameter (<4%) is observed after gold deposition due to slight coverage of the metal layers on the nanohole sidewalls.

Nanoplasmonic structures, such as photonic crystals (PhCs), offer unique opportunities to tailor the spatial extent of the electromagnetic field and control the strength of the light-matter interaction. Guided resonances that are delocalized in the plane and tightly confined in the vertical direction are used. The periodic index contrast of the structures enables the excitation of the guided resonances with a plane-wave illumination at normal incidence and their out-coupling into the radiation modes. Such a surface normal operation eliminates the alignments of sensitive prism/waveguide/fiber coupling schemes needed by other optical nanosensors. The ease of resonance excitation by surface normal light is particularly advantageous for high-throughput micro-array applications. The incident light is transmitted by PhC slabs through two different pathways. One of them is the direct pathway, where a portion of the electromagnetic field goes straight through the slab. The other is the indirect pathway, where the remaining portion couples into the guided resonances before leaking into the radiation modes. These two pathways interfere with each other and result in resonances with sharp Fano-type asymmetric line-shapes. The spectral location of the resonances is highly sensitive to the refractive index changes occurring within the surroundings of PhC slabs. The index change due to the accumulation of bio-molecules or variations in the bulk solution could be detected optically in a label-free fashion.

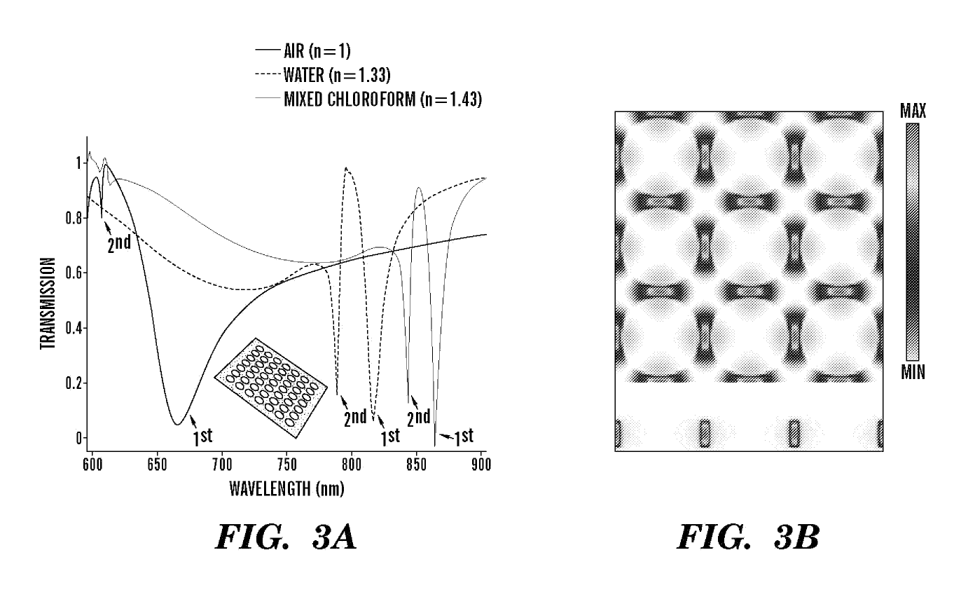

To experimentally implement the proposed sensor, a square lattice SiNₓ PhC slabs (inset in FIG. 3A) was used. FIG. 3A shows the transmission spectra of a specific design calculated by three dimensional finite-difference time-domain (3D-FDTD) method in three different media: air (refractive index n=1), water (n=1.33), and an TPA-chloroform mixture (n=1.43). A normally incident plane wave source (corresponding to the □-point in the dispersion diagram) excites the eigenmodes of the system. For each case, two modes are observed within the given spectral range. FIG. 3B shows the intensity distribution of the lowest (first) order mode when the structure is in air. The field has four-fold symmetry as the lattice and well confined within the slab in the vertical direction. Within the plane, the field extends into the holes, which is crucial in increasing the field overlap with the surrounding media for higher sensitivity. The bulk sensitivity (in units of nm/RIU) was calculated using the shift of the resonance position in wavelength versus the refractive index change in the surrounding environment. To optimize the structure for higher sensitivity, the effects of the slab thickness and the hole radius were studied by varying the thickness d from 0.1a to 0.3a and the radius r from 0.3a to 0.45a (a is the periodicity). For all the analyzed structures, the resonant wavelength of the lowest order mode in air was scaled to 670 nm. The calculated sensitivities and the parameter sets for each case are shown in Table 1.

TABLE 1
Sensitivity results with different hole radius
and slab thickness (in unit of nm/RIU)

r

| d | 0.3a | 0.35a | 0.4a | 0.45a |
|---|---|---|---|---|
| 0.1a | 405 | 485 | 490 | 560 |
| 0.15a | 317 | 351 | 422 | 535 |
| 0.2a | 236 | 344 | 370 | 500 |
| 0.3a | 230 | 281 | 307 | 388 |

The sensitivity improves as the size of the holes increases and the slab thickness decreases. When r=0.45a and d=0.1a, the sensitivity reaches 560 nm/RIU. As the sensitivity scales with wavelength, shifting the resonances to the longer wavelength (such as 1550 nm range) can increase the sensitivity even further (well above 1000 nm/RIU).

The optimized PhC structures are fabricated on free standing SiNₓ membranes according to the process flow described in FIGS. 2A-2D. SEM images indicate that the diameter and the periodicity are 540 nm and 605 nm, respectively. Ellipsometer measurements are taken on the unpatterned area of the membrane to confirm that the slab thickness is ˜90 nm. These numbers are quite close to the optimized design with r/a=0.45 and d/a=0.15. For the PhC with periodicity of 605 nm, the resonance peak in air is located at ˜670 nm.

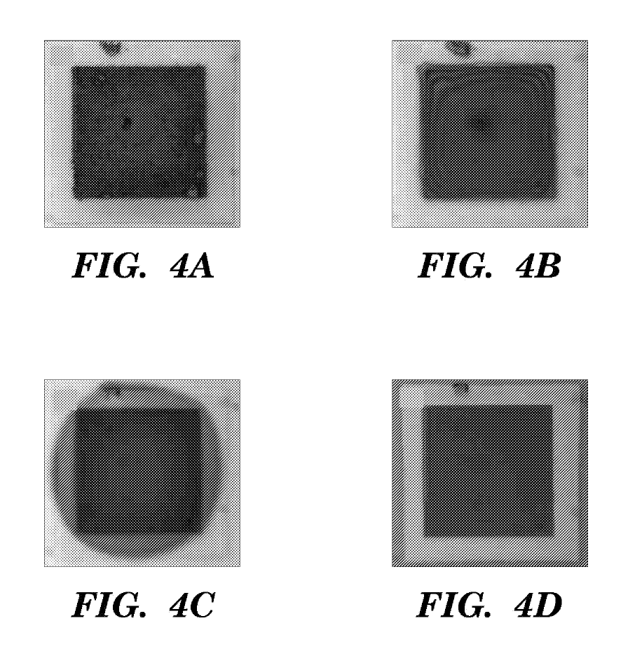

To carry out the flow tests, the structures are integrated in a chamber with two inlets/outlets both on the top and the bottom channels fabricated in polydimethylsiloxane (PDMS). To implement the laminar flow scheme, where the convective flow is parallel to the surface (FIGS. 1B and 1D), the inlet/outlet of the bottom channel was blocked. To steer the convective flow actively towards the sensing surface, one of the openings of the both channels was blocked (FIGS. 1A and 1C). The PhC slab is sealed perfectly to ensure the flow is only through the openings. Video images of the perpendicular convective flow, captured in a microscope with a CCD camera, are shown in FIGS. 4A-4D. Here, the IPA solution is pumped into the bottom channel by a syringe at a rate of 80 μL/s. The video recording starts when the bottom channel is almost filled-up. FIGS. 4A-4D show the merge of IPA to the top channel only through the openings, confirming the active steering of the liquid flow. No damage or breakage of the membrane due to the applied pressure is observed.

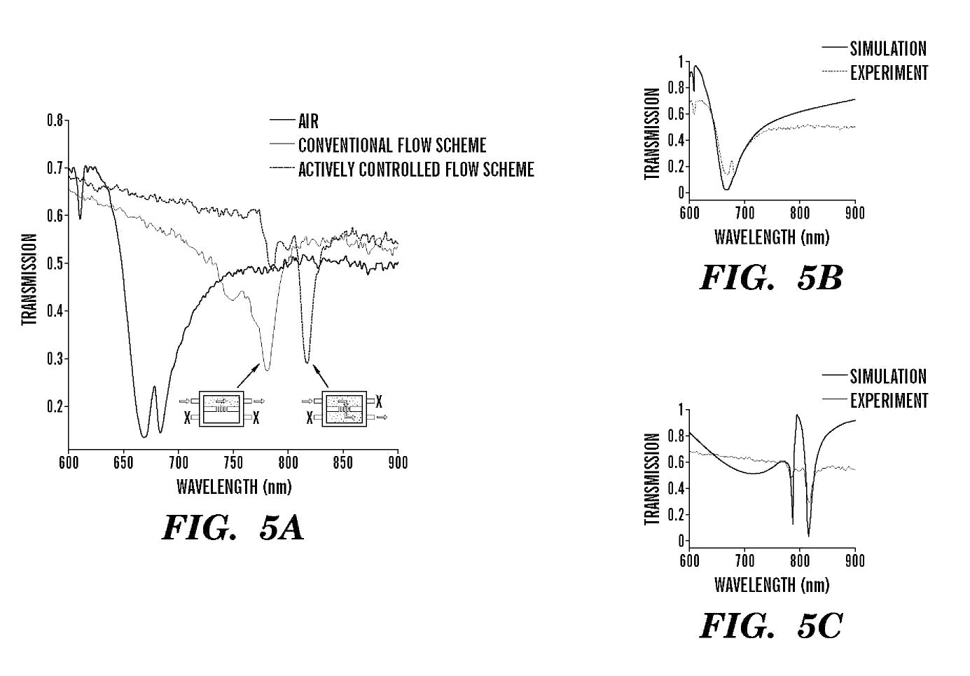

To experimentally evaluate the sensing response of the different flow schemes, transmission spectra of PhCs are obtained by launching a collimated and unpolarized light at normal incidence. The transmitted signal is collected with a 0.7 numerical aperture objective lens and coupled into a spectrometer for spectral analysis. A comparison of the transmitted spectra is shown in FIGS. 5A-5C. Blue curve is the transmission spectrum taken in air, which clearly shows the excitation of the lowest and the next higher order modes at 667 nm and 610 nm, respectively. The red and the green curves are the responses in the solution (DI-water) for both flow schemes. When the convective flow is parallel to the surface (green curve), no leakage to the bottom surface is observed due to the large surface tension of the DI-water. On the other hand, when the convective flow is actively directed through the openings, PhC membrane is totally immersed in DI-water. This results in a larger refractive index change and more than 40 nm additional resonance shift. This observation is also confirmed by numerical simulations. 3D-FDTD calculations are performed for the PhCs in air and totally immersed in water. The slab parameters are obtained from SEM images and ellipsometer measurements. FIGS. 5B and 5C show the simulation results overlaid directly with the experimental measurements without any shifting. Near perfect match between the resonance locations and the line-widths are observed for both modes. There is a slight distortion in the resonance shape of the first mode in air, which could be due to fabrication disorder. We also performed simulation for the case in which water fills only the top channel (such that the holes and the bottom channel are still in air). The calculated resonance position for the lowest order mode is nearly same with the experimental result. This indicates that due to the large surface tension, solutions cannot penetrate through the nanoholes if no steering method is employed. It was observed that the widths of the resonance peaks are significantly narrower when the structure is immersed in solution. This is due to the reduction of the index contrast within the slab resulting in less efficient coupling with the radiation continuum. With reduced index contrast (which could be, without wishing to be bound or limited by theory, due to immersion in solution or reduction of hole size), guided resonances asymptotically turns into fully confined slab modes (with infinite Q factor and narrow line-width).

FIG. 5A shows an experimental comparison of transmission spectra for two different flow schemes. Actively controlled flow scheme (red) shows better sensitivity and narrower linewidth compared to the conventional scheme (green). FIG. 5B shows experimentally measured transmission spectrum in air (blue) overlaid with the simulation result (black). FIG. 5C shows experimentally measured transmission spectrum in water (red) overlaid with the simulation result (black).

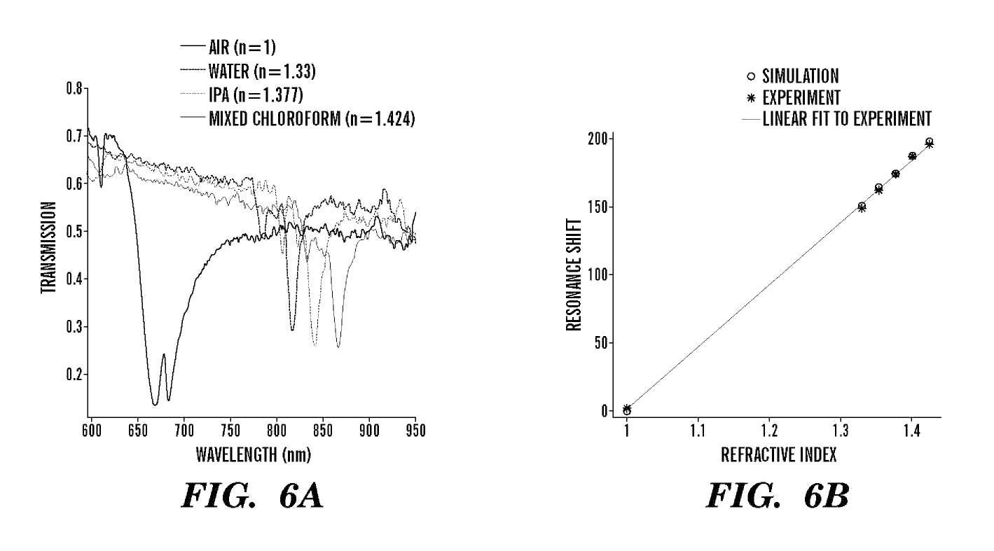

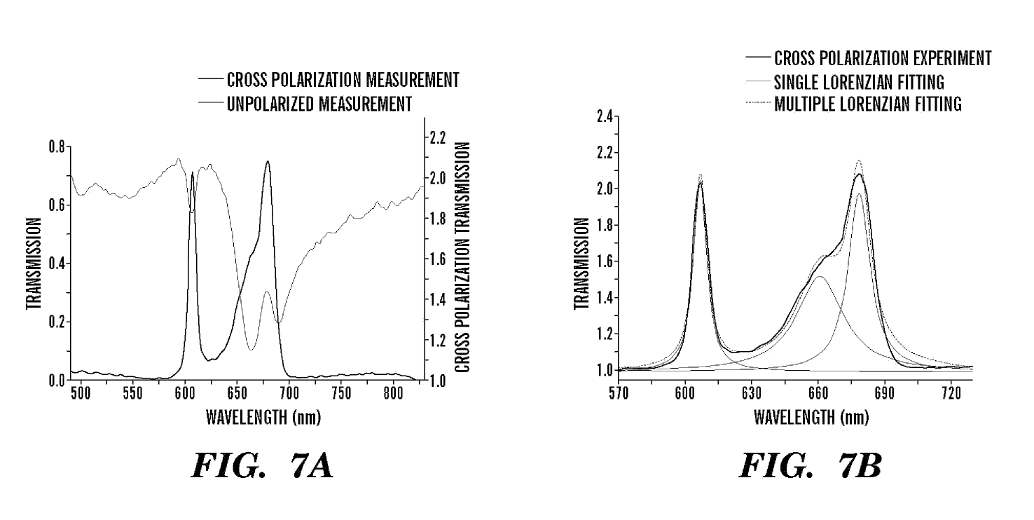

Bulk sensitivity of the PhCs are tested by successively applying five different solutions through the directed flow scheme: DI-water, acetone, IPA and two IPA-chloroform mixtures with refractive indices of 1, 1.33, 1.356, 1.377, 1.401 and 1.424, respectively. The refractive indices of all the liquids are initially measured using a commercial refractometer. The measurements are performed by slowly pumping the solution to the chamber at 50 μL/s pumping rate. Prior to each measurement, we make sure the former solution is entirely replaced by the new one. As shown in FIG. 6A, with increasing refractive index the resonances red-shift and the line-widths become narrower. The linewidth of the resonance in DI-water is measured to be ˜10 nm. FIG. 6B shows the shift in resonance wavelength versus the refractive index of the liquid. The agreement between the experimental data and the theoretically predicted shifts is excellent. The experimentally measured sensitivity of the sensor, 510 nm/RIU for operation around 850 nm in wavelength.

FIG. 6A shows experimentally measured transmission spectra of a PhC slab using actively controlled delivery scheme in air (blue), water (red), IPA (green) and an IPA-chloroform mixture (black). FIG. 6B shows shifts of the 1st resonant peaks in wavelength versus the surrounding refractive index change. Resonance peak positions found in experiments (blue stars) match very well with the simulation results (green circles). Red line is a linear fitting to the experimental results.

As described herein, with the sensor systems provided herein, refractive index changes can be effectively detected by tracking the resonance shifts with a spectrometer. On the other hand, in some embodiments, detecting the index change by a laser/CCD system through intensity modulation offers advantages for highly multiplexed sensing. In such a read-out setting, however, it is crucial to have sharp resonances with large signal-to-noise ratios. This can be achieved by using cross-polarization measurements. As mentioned above, the transmission spectra result from interference of two optical paths: one is the direct transmission while the other is through the guided resonances. When an unpolarized light is employed and all the light transmitted through the slab collected, both pathways contributes to the detected signal. However, if a polarized light is launched and the signal after an analyzer oriented perpendicular to the polarizer is collected, only the scattering from the guided resonances contributes. This results in dramatic suppression of the background and isolation of the resonances with large signal-to-noise ratios. In addition, the cross-polarization measurements result in purely Lorentzian-shape resonance profiles with narrower line-widths. FIG. 7A compares the cross-polarization spectrum (red) with the regular one (blue). The spectra are taken when the structure is in air. Cross-polarization measurements clearly isolate two distinct resonance features from the background. A single Lorentzian with 7 nm line-width fits very well with the second order mode resonance (FIG. 7B). On the other hand, two Lorenztians are needed to fit the lowest order mode (FIG. 7B). This indicates a potential resonance splitting for the lowest order mode, which could be due to a slight non-uniformity in fabrication. The addition of three Lorentzians (red dashed curve in FIG. 7B) matches very well with the experimentally measured spectrum.

It will be appreciated that in certain circumstances, minute amounts of biomolecular targets from small quantities of analytes or biological samples may result in very small resonance peak shifts. In such circumstances, narrow resonances with large signal-to-noise ratios should be used. This can be achieved, in some embodiments, by using cross-polarization measurements. As mentioned above, the transmission spectra result from interference of two optical paths: one is the direct transmission while the other is through the guided resonances. When an unpolarized light is employed and all the light transmitted through the slab is collected, both pathways contributes to the detected signal. However, a polarized light is launched and the signal is collected after an analyzer oriented perpendicular to the polarizer, only the scattering from the guided resonances contributes. This results in dramatic suppression of the background and isolation of the resonances with large signal-to-noise ratios. In addition, the cross-polarization measurements result in purely Lorentzian-shape resonance profiles with narrower line-widths. FIG. 7A compares the cross-polarization spectrum (Line 1) with the regular one (Line 2). The spectra are taken when the structure is in air. Cross-polarization measurements clearly isolate two distinct resonance features from the background. A single Lorentzian with 7 nm line-width fits very well with the second order mode resonance (FIG. 7B). On the other hand, two Lorenztians are needed to fit the lowest order mode (FIG. 7B). This indicates a potential resonance splitting for the lowest order mode, which could be due to a slight non-uniformity in fabrication. The addition of three Lorentzians (dashed curve in FIG. 7B) matches very well with the experimentally measured spectrum.

Novel sensors combining nanophotonics and nanofluidics on a single platform are described herein. By using nanoscale openings in PhCs, both light and fluidics can be manipulated on chip. Compared to the laminar flow in conventional fluidic channels, active steering of the convective flow results in the direct delivery of the stream to the nanohole openings. This can lead to enhanced analyte delivery to the sensor surface by overcoming the mass transport limitations. This method may be applied to detect refractive index changes in aqueous solutions. Bulk measurements show that actively directed convective flow results in better sensitivities. The sensitivity of the sensor reaches 510 nm/RIU for resonance located around 850 nm with a line-width of ˜10 nm in solution. In addition, a cross-polarization measurement can be employed to further improve the detection limit by increasing the signal-to-noise ratio.

### Nanoplasmonic Sensors and Detection of Biomolecular Targets

Described herein are rapid, sensitive, simple to use, and portablenanoplasmonic biosensors that are useful for a variety of applications involving the detection of biomolecular targets in samples and analytes, ranging from research and medical diagnostics, to detection of agents used in bioterrorism. Such targets include, but are not limited to, polynucleotides, peptides, small proteins, antibodies, viral particles, and cells. Furthermore, the biosensors described herein have the ability to simultaneously quantify many different biomolecular interactions and formation of biomolecular complexes with high sensitivity for use in pharmaceutical drug discovery, proteomics, and diagnostics. Such biomolecular complexes include, for example, oligonucleotide interactions, antibody-antigen interactions, hormone-receptor interactions, and enzyme-substrate interactions.

The ability to detect biological target molecules, such as DNA, RNA, and proteins, as well as nanomolecular particles, such as virions, is fundamental to understanding both cell physiology and disease progression, as well as for use in various applications such as the early and rapid detection of disease outbreaks and bioterrorism attacks. Such detection, however, is limited by the need to use labels, such as fluorescent molecules or radiolabels, which can alter the properties of the biological target, e.g., conformation, and which can add additional, often time-consuming, steps to a detection process.

The direct detection of biochemical and cellular binding without the use of a fluorophore, a radioligand or a secondary reporter, using the nanoplasmonic biosensors and methods described herein, removes the experimental uncertainty induced by the effect of a label on, for example, molecular conformation, the blocking of active binding epitopes, steric hindrance, inaccessibility of the labeling site, or the inability to find an appropriate label that functions equivalently for all molecules or targets in a sample. The sensors and detection methods described herein greatly simplify the time and effort required for assay development, while removing experimental artifacts that occur when labels are used, such as quenching, shelf life, and background fluorescence.

### Detection of Sub-Cellular Biomolecular Targets

The nanoplasmonic biosensors and methods of use thereof provided herein are suitable for the detection of a wide variety of biomolecular targets present in a sample or analyte. Such biomolecular targets include, but are not limited to, sub-cellular molecules and structures, such as polynucleotides and polypeptides present in a sample. Binding of one or more of these molecules to the surface of the biosensors described herein causes a change in the optical properties, relative to the optical properties of the sensor surface in the absence of binding, that can be measured by an optical detector, thus allowing the biosensor to indicate the presence of one or more binding events. In addition, the biosensors described herein can be designed to have immobilized capture agents bound to the sensor surface, such that a change in an optical property is detected by the biosensor upon binding of one or more biomolecular targets present in a sample to one or more of the immobilized capture agents present on the substrate surface. Such nanoplasmonic biosensors are useful for the detection of a variety of biomolecular interactions, including, but not limited to, oligonucleotide-oligonucleotide, oligonucleotide-protein, antibody-antigen, hormone-hormone receptor, and enzyme-substrate interactions.

The biosensors of the invention can be used, in some embodiments, to study one or a number of specific binding interactions in parallel, i.e., multiplex applications. Binding of one or more biomolecular to their respective capture agents can be detected, without the use of labels, by applying a analyte or sample comprising one or more biomolecular targets to a biosensor that has one or more specific capture agents immobilized on its surface. The biosensor is illuminated with an optical source, such as light source, and if one or more biomolecular targets in the sample specifically binds one or more of the immobilized capture agents, the surface plasmon resonance of the biosensor changes causing a change in an optical property relative to the optical property when one or more biomolecular targets have not bound to the immobilized capture agents. In those embodiments where a biosensor comprises an array of one or more distinct locations comprising one or more specific capture agents, then the desired optical property can be detected from each distinct location of the biosensor.

Accordingly, in one aspect, provided herein are nanoplasmonic biosensor arrays comprising a substrate and a metal film disposed upon the substrate. In such aspects, the metal film comprises one or more surfaces comprising an array of nanoelements arranged in a pattern, the nanoelements have a dimension less than one wavelength of an incident light source to which the metal film produces surface plasmons, and the metal film is activated with an activating agent. The nanoplasmonic elements can be arranged in any pattern that gives rise to a desired optical property for the nanoplasmonic biosensor array, including both periodic patterns and non-periodic patterns, such as pseudo-random and random patterns. Accordingly, in some embodiments of this aspect, the pattern of nanoelements is a periodic pattern. In some embodiments of this aspect, the pattern of nanoelements is a non-periodic pattern, such as a pseudo-random pattern or a random pattern.

The metals used in the nanoplasmonic structures described herein, such as the nanoplasmonic biosensor arrays, are selected on the basis of their surface plasmon properties when an incident light source illuminates their surface. The metal used can be in the form of a metal film in which nanoelements, such as nanoholes of a desired diameter or dimension shorter than the wavelength of the incident light, or in the form of metallic nanoparticles on the surface of a substrate. Accordingly, the metal used can be a Noble metal, or any metal selected from the group consisting of gold, rhodium, palladium, silver, osmium, iridium, platinum, titanium, and aluminum. The nanoplasmonic elements, such as nanoparticles, in some embodiments, can comprise multiple metals.

In those nanoplasmonic structures comprising a metallic film, the thickness of the film used can vary. The thickness of the metal film is preferably between 50-500 nm thick, between 50-450 nm thick, between 50-400 nm thick, between 50-350 nm thick, between 50-300 nm thick, between 50-250 nm thick, between 50-200, or between 75-200 nm thick.

Substrate materials or support materials refer to materials upon which a metallic film or nanoplasmonic element is disposed. Examples of substrate materials for use in the nanoplasmonic biosensor arrays described herein include, but are not limited to, silicon dioxide, silicon nitride, glass, quartz, MgF₂, CaF₂, or a polymer, such as a polycarbonate or Teflon.

Preferably, the metal film comprising one or more nanoelements used in the nanoplasmonic biosensor arrays described herein produces surface plasmons to wavelengths of light in the UV-VIS-IR spectral range. Ultraviolet (UV) light wavelengths can range from approximately 10 nm to 400 nm. Preferably, the range of UV wavelengths that elicit surface plasmon resonance in the nanostructures described herein, such as the nanoplasmonic biosensor arrays, are from 100 nm to 400 nm. The visible spectrum of light ranges from approximately 380 nm to 750 nm. Wavelengths within the infrared spectrum of light can range from 750 nm to 100,000 nm. Preferably, the infrared wavelengths that elicit surface plasmon resonance in the nanostructures described herein, such as the nanoplasmonic biosensor arrays, range from 750 nm to 3000 nm, from 750 nm to 2000 nm, or from 750 nm to 1000 nm.

In order to elicit surface plasmon resonance in the nanostructures described herein, an incident optical source producing light having wavelengths within a range useful for eliciting surface plasmon resonance is required. Such an incident optical light source can be a polychromatic illumination device or a broad spectral light source, or a monochromatic light source, such as a laser or light emitting diode (LED) having emission spectrum of a desired wavelength(s). In some embodiments, an optical filter can be used to produce light of a desired wavelength. In some embodiments, an optical source may further comprise a modulator to shift the phase or polarization of the light, or an actuator to control the angle of the incident light source.

A nanoelement for use in the nanostructures described herein can be of a plasmonic material of any suitable shape or dimension that exhibits surface plasmon resonance properties. Such a unit of plasmonic material can be in the form of a nanoparticle and present on or embedded within the surface of a substance or substrate, or can be in the form of a nanohole and present as an aperture within a plasmonic material. Preferably, a nanoelement has at least one dimension in the approximately 1-3000 nm range, for example, in the range of about 1-2500 nm, in the range of about 1-2000 nm, in the range of about 1-1500 nm, in the range of about 1-1000 nm, in the range of about 10 nm to about 1000 nm, in the range of about 10 nm to about 750 nm, in the range of about 10 nm to about 500 nm, in the range of about 10 nm to about 250 nm, in the range of about 10 nm to about 100 nm, in the range of about 5 nm to about 100 nm, or in the range of about 2 nm to about 50 nm.

In some embodiments of the aspect, the nanoelement is a nanohole. In some such embodiments, the nanohole is a through nanohole that completely penetrates the metal film. In other embodiments, the nanohole is a non-through nanohole that does not completely penetrate the metal film. In some embodiments of the aspect, at least one dimension of the nanohole is between 10-1000 nm. In some embodiments of the aspect, at least one dimension of the nanohole is between 50-300 nm.

The periodicity of the nanoelements can also play a role in increasing or enhancing surface plasmonic resonance effects in a nanostructure. In some embodiments, the nanoelements are separated by a periodicity of between 100-1000 nm, between 100-900 nm, 100-800 nm, 100-700 nm, between 100-600 nm, 100-500 nm, 100-400 nm, between 100-300 nm, or between 100-200 nm. In some embodiments, the periodicity is between 400-800 nm or between 500-700 nm.

The nanoplasmonic biosensor arrays described herein can further comprise an adhesion later between the metal film and the substrate to help fix the metal film to the substrate it is disposed upon. In some such embodiments, the adhesion layer comprises titanium or chromium. The adhesion layer is preferably a thin layer, of a thickness less than that of the metal film. The thickness of the adhesion layer can be 50 nm or less, 45 nm or less, 50 nm or less, 35 nm or less, 30 nm or less, 25 nm or less, 20 nm or less, 15 nm or less, or 10 nm or less, 5 nm or less. In some embodiments, the thickness of the adhesion layer is in the range of 1 nm-20 nm, in the range of 1 nm-10 nm, in the range of 2 nm-9 nm, in the range of 3 nm-8 nm, or in the range of 4 nm-7 nm. In some embodiments, a through nanohole also completely penetrates the adhesion layer.

It is also desirable, in some embodiments, to activate a surface of the metal of the nanoplasmonic structure using an activating agent. As used herein, “activating” the surface of the metal refers to treating it with an activating agent in order to allow, permit or enhance the binding of a capture agent. The activating agent can be chosen on the basis of the nature of the capture agent used with the nanoplasmonic structure, for example, whether the capture agent is a protein or a nucleic acid. Accordingly, in some embodiments, when the capture agent is a protein, the activating agent used to activate a metal surface is a piranha solution.

A metallic surface of a nanoplasmonic structure can also be functionalized using one or more specific capture agents. The metallic surface can be that of a nanoelement, such as a nanoparticle or nanohole (for example, along the side and/or bottom of a nanohole), on the surface of the metallic film comprising an array of nanoholes, or any combination thereof. Accordingly, as used herein, “functionalization” refers to adding to the surface of the metal of a nanoplasmonic biosensor one or more specific capture agents. In some embodiments, the surface of a photonic crystal can be functionalized. In some embodiments, the metallic surface is first activated, then functionalized. In other embodiments, functionalization of a metallic surface, such as a metallic film comprising one or more nanoholes, or a metallic nanoparticle, can be performed in the absence of activation.

The capture agent used to functionalize a nanoplasmonic biosensor should have specific binding properties for one or more biomolecular targets. As used herein, a “capture agent” refers to any of a variety of specific binding molecules, including, but not limited to, a DNA oligonucleotide, an RNA oligonucleotide, a peptide, a protein (e.g., transcription factor, antibody or antibody fragment thereof, receptor, a recombinant fusion protein, or enzyme), a small organic molecule, or any combination thereof, that can be immobilized onto the surface of the nanoplasmonic structures described herein, such as a nanoplasmonic biosensor array. In some embodiments, the capture agent is immobilized in a periodic fashion. For example, one or more specific immobilized capture agents can be arranged in an array at one or more distinct locations on the surface of the nanoplasmonic biosensor array. In some such embodiments, capture agents specific for different biomolecular targets are immobilized at such distinct locations on the surface of a nanoplasmonic structure, such that the structure can be used to detect multiple biomolecular targets in a sample. In other embodiments, the capture agent is immobilized in a non-periodic or random fashion. For high-throughput applications, a nanoplasmonic biosensor array can be arranged in an array of such arrays, wherein several biosensors comprising an array of specific capture agents on the nanoplasmonic structure surface are further arranged in an array.

Such functionalized biosensors are useful for the detection of biomolecular interactions, including, but not limited to, DNA-DNA, DNA-RNA, DNA-protein, RNA-RNA, RNA-protein, and protein-protein interactions. For example, a nanoplasmonic biosensor array having a plurality of DNA oligonucleotides immobilized on the surface can be used to detect the presence of a protein, such as a transcription factor, present in a sample contacted with the substrate layer, that binds to one or more of the oligonucleotides.

Thus, in some embodiments, the metallic surface of a nanoplasmonic structure is functionalized with a capture agent comprising one or more of a plurality of immobilized DNA oligonucleotides. In some embodiments, the metallic surface of a nanoplasmonic structure is functionalized with a capture agent comprising one or more of a plurality of immobilized RNA oligonucleotides. In some embodiments, the metallic surface of a nanoplasmonic structure is functionalized with a capture agent comprising one or more of a plurality of immobilized peptides. In some embodiments, the metallic surface of a nanoplasmonic structure is functionalized with a capture agent comprising one or more of a plurality of immobilized proteins. In some such embodiments, the protein is an antigen. In other such embodiments, the protein is a polyclonal antibody, monoclonal antibody, single chain antibody (scFv), F(ab) fragment, F(ab′)₂ fragment, or an Fv fragment. In other such embodiment, the protein is an enzyme, a transcription factor, a receptor, or a recombinant fusion protein.

The functionalization of the metallic surface of a nanoplasmonic structure can also occur in multiple steps using one or more specific capture agents, in order to provide greater specificity for one or more biomolecular targets. Thus, in some embodiments, a first capture agent and a second capture agent are used to functionalize a nanoplasmonic structure, such that the first capture agent is specific for the second capture agent, and the second capture agent is specific for one or more biomolecular targets. For example, a first capture agent specific for a common domain present in a variety of different second capture agents can be used to immobilize all capture agents having that common domain. Non-limiting examples of such common domains include constant regions of immunoglobulins or antibodies, DNA-binding domains of transcription factors, and the like. Accordingly, in one embodiment, the first capture agent is protein A/G, and the second capture agent comprises one or more antibodies or antibody fragments thereof. In some such embodiments, the one or more antibodies or antibody fragments thereof are all specific for a particular class of biomolecular targets, for example, a family of related viruses. In other embodiments, the one or more antibodies or antibody fragments thereof have specificities for a variety of unrelated biomolecular targets.

A sample or analyte can be applied to or contacted with a nanoplasmonic structure, using nanofluidics or other methods known to one of skill in the art, in such a way to allow a biomolecular target present in the sample to bind to the nanoplasmonic structure or capture agent present on the nanoplasmonic structure. In some embodiments, the nanoplasmonic structure itself possesses nanofluidic properties. In other embodiments, a sample or analyte can be directly applied to or contacted with the surface of the nanoplasmonic structure.

A sample or analyte can be any sample to be contacted with a nanoplasmonic structure as described herein, such as a nanoplasmonic biosensor array, for detection of one or more biomolecular targets, such as, for example, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, prostatic fluid, or cellular lysates. A sample can also be obtained from an environmental source, such as water sample obtained from a polluted lake or other body of water, or a liquid sample obtained from a food source believed to contaminated.

In some aspects, provided herein are nanoplasmonic biosensor systems for detecting one or more biomolecular targets comprising: (i) any of the nanoplasmonic biosensor arrays described herein; (ii) a device for contacting one or more samples comprising one or more biomolecular targets to the metal film surface(s) of the nanoplasmonic biosensor array; (iii) an incident light source for illuminating a surface of the metal film to produce surface plasmons; and (iv) an optical detection system for collecting and measuring light displaced from the illuminated metal film, where the displaced light is indicative of surface plasmon resonance on one or more surfaces of said metal film.

The device for contacting one or more samples for use in the nanoplasmonic biosensor systems described herein can be any device or mechanism by which a sample can be brought into contact with the detecting surface of the nanoplasmonic biosensor array to allow a biomolecular target present in the sample to bind to the nanoplasmonic structure or capture agent present on the nanoplasmonic structure. For example, in some embodiments, a microfluidic device that can supply the sample along with a buffer and other reactants to the nanoplasmonic biosensor array can be used. Such a device can provides a first microchannel for the introduction of the sample onto the nanoplasmonic biosensor array, and a second microchannel for removing the compacted sample to a reservoir, such as a water reservoir. Additional microchannels may be provided for other purposes. In some embodiments, the nanoplasmonic structure itself can take advantage of possessing nanofluidic properties, as described herein, whereby the nanoholes of the nanoplasmonic structures are used as nanochannels to direct a sample supplied through, e.g., a microfluidic device, below, through, and on the functionalized surface of the nanoplasmonic biosensor array. Thus, detection of optical properties with and without microfluidics can occur. For example, in some embodiments, a sample or analyte can be directly applied to or contacted with the surface of the nanoplasmonic structure, for example, by applying the sample using a pipette, or by immersing the nanoplamonic structure in the fluid sample, whereas in other embodiments, the nanoplasmonic biosensor array are used in combination with a fluid flow device for contacting the sample(s).

The incident optical light source for use in such nanoplasmonic biosensor systems can be a polychromatic illumination device or a broad spectral light source, such as a gas discharge lamp (mercury lamps, sodium vapor lamps, xenon lamps, mercury-xenon lamps), a gar arced pulse lamp, an incandescent lamp, or a light emitting diode (LED) having a broad emission spectrum; a monochromatic light source, such as a laser or LED having emission spectrum of a desired wavelength(s), or any combination thereof. In some embodiments, an optical filter can be used to produce light of a desired wavelength. In some embodiments, an optical source may further comprise a modulator to shift the phase or polarization of the light, or an actuator to control the angle of the incident light source.

The optical detection system for collecting and measuring light displaced refers to any instrument that either processes light waves to enhance an image for viewing, or analyzes light waves (or photons) to determine one of a number of characteristic optical properties. Known optical detection system for determining optical properties include, but are not limited to, microscopes, cameras, interferometers (for measuring the interference properties of light waves), photometers (for measuring light intensity); polarimeters (for measuring dispersion or rotation of polarized light), reflectometers (for measuring the reflectivity of a surface or object), refractometers (for measuring refractive index of various materials), spectrometers or monochromators (for generating or measuring a portion of the optical spectrum, for the purpose of chemical or material analysis), autocollimators (used to measure angular deflections), and vertometers (used to determine refractive power of lenses such as glasses, contact lenses and magnifier lens).

In some embodiments of the aspect, the optical detection system is a spectrometer. A “spectrograph” or “spectrometer” refers to an optical instrument used to measure properties of light over a specific portion of the electromagnetic spectrum, typically used in spectroscopic analysis to identify materials. The variable measured is most often the light's intensity but could also, for instance, be the polarization state. The independent variable is usually the wavelength of the light, normally expressed as a fraction of a meter, but sometimes expressed as a unit directly proportional to the photon energy, such as wavenumber or electron volts, which has a reciprocal relationship to wavelength. If the region of interest is restricted to near the visible spectrum, the study is called spectrophotometry using a spectrophotometer.

In some embodiments of the aspect, the optical detection system is a spectrophotometer. As defined herein, a “spectrophotometer” is a photometer (a device for measuring light intensity) that can measure intensity as a function of the color, or more specifically, the wavelength of light. There are many kinds of spectrophotometers. Among the most important distinctions used to classify them are the wavelengths they work with, the measurement techniques they use, how they acquire a spectrum, and the sources of intensity variation they are designed to measure. Other important features of spectrophotometers include the spectral bandwidth and linear range. There are two major classes of spectrophotometers; single beam and double beam. A double beam spectrophotometer measures the ratio of the light intensity on two different light paths, and a single beam spectrophotometer measures the absolute light intensity. Although ratio measurements are easier, and generally more stable, single beam instruments have advantages; for instance, they can have a larger dynamic range, and they can be more compact. Historically, spectrophotometers use a monochromator to analyze the spectrum, but there are also spectrophotometers that use arrays of photosensors. Especially for infrared spectrophotometers, there are spectrophotometers that use a Fourier transform technique to acquire the spectral information quicker in a technique called Fourier Transform InfraRed. The spectrophotometer quantitatively measures the fraction of light that passes through a given solution. In a spectrophotometer, a light from the lamp is guided through a monochromator, which picks light of one particular wavelength out of the continuous spectrum. This light passes through the sample that is being measured. After the sample, the intensity of the remaining light is measured with a photodiode or other light sensor, and the transmittance for this wavelength is then calculated. In short, the sequence of events in a spectrophotometer is as follows: the light source shines through the sample, the sample absorbs light, the detector detects how much light the sample has absorbed, the detector then converts how much light the sample absorbed into a number, the numbers are transmitted to a comparison module to be further manipulated (e.g. curve smoothing, baseline correction). Many spectrophotometers must be calibrated by a procedure known as “zeroing.” The absorbency of some standard substance is set as a baseline value, so the absorbencies of all other substances are recorded relative to the initial “zeroed” substance. The spectrophotometer then displays % absorbency (the amount of light absorbed relative to the initial substance). The most common application of spectrophotometers is the measurement of light absorption, but they can be designed to measure diffuse or specular reflectance.

The nanoplasmonic biosensor systems can also further comprise or be in communication with a controlling device, such as, for example, a computer or a microprocessor. The controlling device can determine, for example, the rate of fluids used for transferring the sample to the nanoplasmonic biosensor array, and/or compile and analyze the optical properties detected by the optical detection system.

Accordingly, the novel technologies and nanoplasmonic biosensor systems described herein are useful in applications where large numbers of biomolecular interactions are measured in parallel, particularly when molecular labels will alter or inhibit the functionality of the biomolecular targets under study. High-throughput screening of pharmaceutical drug compound libraries with protein biomolecular targets, and microarray screening of protein-protein interactions for proteomics are non-limiting examples of applications that require the sensitivity and throughput afforded by the systems and approaches described herein.

The structures and methods described herein can also be used to determine kinetic and affinity constants for molecular interactions between a biomolecular target in a sample and an immobilized molecule attached to the substrate, including association constants, dissociation constants, association rate constants, and dissociation rate constants. The structures and methods provided herein can also be used to determine the concentration of one or more biomolecular targets in a sample, such as viral concentration in a blood sample.

Some embodiments of the invention provide a method of detecting whether a biomolecular target inhibits the activity of an enzyme or binding partner, i.e., “inhibition activity” of the biomolecular target. In one such embodiment, a sample comprising one or more biomolecular targets to be tested for having inhibition activity is contacted with a biosensor comprising one or more immobilized molecules. This is followed by adding one or more enzymes known to act upon at least one of the immobilized molecules on the biosensor substrate. Where the one or more enzymes have altered the one or more immobilized molecules on the substrate surface of the biosensor, for example, by cleaving all or a portion of an immobilized molecule from the surface of a biosensor, a shift in the interference pattern is detected by the biosensor. Thus, a sample comprising a biomolecular target having no inhibition activity allows the enzyme activity to occur unabated, such that the resonance pattern or refractive index changes upon addition of the enzyme(s); a biomolecular target with substantially complete inhibition activity halts the reaction substantially completely, such that no change in resonance pattern or refractive index is detected by the biosensor upon addition of the enzyme(s); and a biomolecular target with partial inhibition halts the reaction partially, resulting in an intermediate shift in the resonance pattern or refractive index upon addition of the enzyme(s).

Further, in some embodiments, the nanoplasmonic biosensor arrays described herein can be used to detect a change in an optical property, such as a resonance pattern or refractive index at one or more distinct locations on a nanoplasmonic biosensor surface. For example, when the nanoplasmonic biosensor is used to identify biomolecular targets having enzymatic inhibition activity, the samples comprising one or more biomolecular targets is contacted with one or more distinct locations on the nanoplasmonic biosensor surface, and then one or more enzymes are contacted at these distinct locations. The desired optical property, such as the resonance pattern of the one or more distinct locations, is then detected and compared to the initial optical resonance pattern. In other embodiments, the sample comprising one or more biomolecular targets being tested for inhibitory activity is mixed with the one or more enzymes, which can be contacted to the one or more distinct locations, and the desired optical property is compared to the optical property obtained when no biomolecular targets are present in the sample.

### Detection of Viral Biomolecular Targets

While some success had been achieved for detecting protein or nucleic acid molecules in a label-free fashion, viral targets have thus far eluded label-free detection strategies. The development of the nanoplasmonic biosensors and methods of use thereof described herein is useful for a variety of applications in which it was not previously possible, feasible, or practical to perform frequent or rapid testing for viruses, such as the fields of pharmaceutical discovery, diagnostic testing, environmental testing, bioterrorism, and food safety. A virus is a small infectious agent that can replicate only inside the living cells (host cells) of other organisms. Most viruses are too small to be seen directly with a light microscope. Additionally, many viruses cannot be cultured as appropriate host cells cannot be cultured. Early and rapid detection of viruses or viral particles is important for detecting contaminations in food supplies, and in protection against bioterrorism threats, as current detection methods, such as electron microscopy, are time-consuming, non-portable, and expensive.

The novel nanoplasmonic biosensors and methods of use thereof described herein unexpectedly provide a new and rapid means by which to detect viral biomolecular targets, with minimal sample processing, and allow for detection of intact viral particles, even in the absence of uniform coating of a sample comprising a viral particle on the biosensor surface. The nanoplasmonic biosensors are designed to have optimal size and spacing (periodicity) of the nanoelements, such as the nanoholes, to allow for viral particles to bind to the functionalized surface of the biosensor. In some embodiments, the size and spacing of the nanoelements of a nanoplasmonic biosensors are designed to permit flow-through of a sample comprising a viral particle. Specificity for a viral biomolecular target can be modified by altering the functionalization of a biosensor surface. Different viral biomolecular targets can be differentiated on the basis of, for example, size, shape, or a combination therein. The inventors have discovered that sufficiently high viral concentrations result in a resonance shift large enough to be detected by the human eye, without the use of an optical detection system. Thus, the nanoplasmonic biosensor systems and methods thereof are also useful in determining concentrations of viruses in a given sample.

The nanoplasmonic biosensors of the invention can be used for multiplex applications whereby one or a number different viruses are studied in parallel. Binding of one or more specific binding viral biomolecular targets can be detected, without the use of labels, by applying a sample comprising one or more biomolecular targets to a nanoplasmonic biosensor that has one or more specific capture agents, such as virus-specific antibodies or fragments thereof, immobilized on the nanoplasmonic surface. The functionalized nanoplasmonic biosensor is illuminated with a light source before and after application of a sample. If one or more viral biomolecular targets in the sample specifically binds one or more of the capture agents, a shift in the resonance pattern or refractive index occurs relative to the resonance pattern or refractive index when one or more specific viral biomolecular targets have not bound to the immobilized capture agents. In those embodiments where a nanoplasmonic biosensor surface comprises an array of one or more distinct locations comprising the one or more specific immobilized virus-specific capture agents, then the resonance pattern or refractive index is detected from each distinct location of the biosensor.

Thus, in some aspects of the invention, a variety of specific capture agents, for example, antibodies, can be immobilized in an array format onto the surface of a nanoplasmonic biosensor described herein. The biosensor is then contacted with a test sample of interest comprising potential viral biomolecular targets. Only the viruses that specifically bind to the capture agents immobilized on the biosensor remain bound to the biosensor.

In some embodiments of the aspect, a nanoplasmonic biosensor surface comprises one or more capture agents specific for different viruses, whereby different locations on the surface comprise capture agents specific for distinct viral species, such that changes in the optical resonance pattern or refractive index at different locations on the surface, upon contacting the sample with the surface, is indicative of the presence of distinct viral species in the sample (e.g., smallpox, Ebola and Marburg viruses). In some embodiments, if the concentration of virus is high enough in the sample, visual detection is sufficient. In other embodiments, an optical detection system such as a spectrophotometer can be used to detect changes in the optical properties of the nanoplasmonic biosensor. Such a biosensor is useful, for example, in the rapid identification of agents used during a bioterrorist attack.

In some embodiments of the aspect, a nanoplasmonic biosensor is functionalized with one or more antibodies or antibody-fragments thereof specific for different influenza hemagglutinins, whereby different locations nanoplasmonic biosensor surface comprise antibodies specific for distinct hemagglutinins, such that changes in the optical resonance patterns at different locations upon contacting a sample with the nanoplasmonic biosensor is indicative of the presence of distinct influenza species (e.g., Influenza A, Influenza B, and Influenza C) in the sample. Such a nanoplasmonic biosensor can distinguish, for example, between the presence of different influenza serotypes in a sample, such as H1N1, H2N2, H3N2, H5N1, H7N7, H1N2, H9N2, H7N2, H7N3, and H10N7.

Exemplary viruses and viral families that can be detected using the biosensors and methods described herein include, but are not limited to: Retroviridae (e.g., human immunodeficiency viruses, such as HIV-1 (also referred to as HTLV-III), HIV-2, LAV or HTLV-III/LAV, or HIV-III, and other isolates, such as HIV-LP; Picornaviridae (e.g., polio viruses, hepatitis A virus; enteroviruses, human Coxsackie viruses, rhinoviruses, echoviruses); Calciviridae (e.g., strains that cause gastroenteritis); Togaviridae (e.g., equine encephalitis viruses, rubella viruses); Flaviviridae (e.g., dengue viruses, encephalitis viruses, yellow fever viruses); Coronaviridae (e.g., coronaviruses); Rhabdoviridae (e.g., vesicular stomatitis viruses, rabies viruses); Filoviridae (e.g., ebola viruses); Paramyxoviridae (e.g., parainfluenza viruses, mumps virus, measles virus, respiratory syncytial virus); adenovirus; Orthomyxoviridae (e.g., influenza viruses); Bungaviridae (e.g., Hantaan viruses, bunga viruses, phleboviruses and Nairo viruses); Arena viridae (hemorrhagic fever viruses); Reoviridae (e.g., reoviruses, orbiviurses and rotaviruses, i.e., Rotavirus A, Rotavirus B. Rotavirus C); Birnaviridae; Hepadnaviridae (Hepatitis A and B viruses); Parvoviridae (parvoviruses); Papovaviridae (papilloma viruses, polyoma viruses); Adenoviridae (most adenoviruses); Herpesviridae (herpes simplex virus (HSV) 1 and 2, Human herpes virus 6, Human herpes virus 7, Human herpes virus 8. varicella zoster virus, cytomegalovirus (CMV), herpes virus; Epstein-Barr virus; Rous sarcoma virus; West Nile virus; Japanese equine encephalitis, Norwalk, papilloma virus, parvovirus B19; Poxyiridae (variola viruses, vaccinia viruses, pox viruses); and Iridoviridae (e.g., African swine fever virus); Hepatitis D virus, Hepatitis E virus, and unclassified viruses (e.g., the etiological agents of Spongiform encephalopathies, the agent of delta hepatitis (thought to be a defective satellite of hepatitis B virus), the agents of non-A, non-B hepatitis (class 1=enterally transmitted; class 2=parenterally transmitted (i.e., Hepatitis C); Norwalk and related viruses, and astroviruses).

### Detection of Sub-Cellular and Cellular Changes

The nanoplasmonic biosensor described herein are also useful for applications involving the detection of changes in cellular and sub-cellular functions in a sample. Such applications include, but are not limited to, testing of pharmaceutical drug candidates on cellular functions, morphology, and growth.

Accordingly, in one aspect, the nanoplasmonic biosensor described herein are used in a method of conducting a cell-based assay of a sample comprising one or more cells, whereby a cellular function being measured by the cell-based assay results in a shift in the optical resonance pattern of the nanoplasmonic biosensor, as detected and measured by an appropriate optical detection system. The resonance pattern detected and measured by the nanoplasmonic biosensor provides can be used to identify and detect, for example, internal and external changes to a cell or cells present in a sample. In some embodiments, the cell-based assay measures a cellular function. In some embodiments, the cellular function is selected from the group consisting of cellular viability, cellular growth or changes in size, phagocytosis, channel opening/closing, changes in intracellular components and organelles, such as vesicles, mitochondria, membranes, structural features, periplasm, or any extracts thereof, and protein distribution.

### Other Applications

The nanoplasmonic described herein can also be used in a variety of other applications. These applications include, but are not limited to, environmental applications (e.g., the detection of pesticides and river water contaminants); detection of non-viral pathogens; determining the presence and/or levels of toxic substances before and following bioremediation; analytic measurements in the food industry (e.g., determination of organic drug residues in food, such as antibiotics and growth promoters; detection of small molecules, such as water soluble vitamins; detection of non-organic chemical contaminants), and the detection of toxic metabolites such as mycotoxins.

This invention is further illustrated by the following examples which should not be construed as limiting. It is understood that the foregoing detailed description and the following examples are illustrative only and are not to be taken as limitations upon the scope of the invention. The terminology used herein is for the purpose of describing particular embodiments only, and is not intended to limit the scope of the present invention, which is defined solely by the claims. Various changes and modifications to the disclosed embodiments, which will be apparent to those, skilled in the art, may be made without departing from the spirit and scope of the present invention.

Further, all patents, patent applications, and publications identified, as well as the figures and tables, are expressly incorporated herein by reference in their entireties, for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

### Examples

### Introduction

Demonstrated herein are optofluidic-nanoplasmonic sensors and methods of use thereof for direct detection of biomolecular targets, such as intact viruses, from analytes, such as biologically relevant media, in a label free fashion with little to no sample preparation. As a group, viruses that utilize RNA as their genetic material make up almost all of the alarming new infectious diseases (Category A, B, and C biothreats) and are a large component of the existing viral threats (influenza, rhinovirus, etc). Some of these viruses, e.g. the Ebola hemorrhagic fever virus are both emerging infectious and biological threat agent^{41,41} Patients presenting with RNA virus infections often show symptoms that are not virus specific⁴³. Thus, there is great interest in developing sensitive, rapid diagnostics for such viruses to help direct proper treatment. Our sensing platform uses capture agents, such as antiviral immunoglobulins, immobilized at the sensor surface for specific capturing of biomolecular targets, such as virions. Unlike PCR, the biosensors and methods described herein allow us to take advantage of group specific antibodies, which have historically been able to identify a broad range of known and even previously unknown pathogens (i.e. novel mutant strains)^{11,44}. In addition, the detection platforms and systems described herein are capable of quantifying concentrations, such as viral concentrations. Such quantitative detection makes it uniquely possible to detect not only the presence of the intact viruses in the analyzed samples, but also the intensity of the infection process. A dynamic range spanning three orders of magnitude from 10⁶ PFU/ml to 10⁹ PFU/ml is shown in experimental measurements proving that the detection platforms and systems described herein enable label-free virus detection within a concentration window relevant to clinical testing to drug screening. We also extended these studies to show the suitability of this technology for other viral types, including enveloped DNA viruses (vaccinia virus)⁴⁵. Another advantage of this platform is that due to the non-destructive nature of detection scheme, captured virions and their nucleic acid load (genome) can be exploited in further studies⁴⁶. In this study, experiments were performed in ordinary biosafety level 1 and 2 laboratory settings without any need for mechanical or light isolation. This technology, enabling fast and compact sensing of biomolecular targets, such as intact viruses, can play an important role in early and point-of-care detection of viruses in clinical settings as well as in biodefense contexts.

Device Operation Principle.

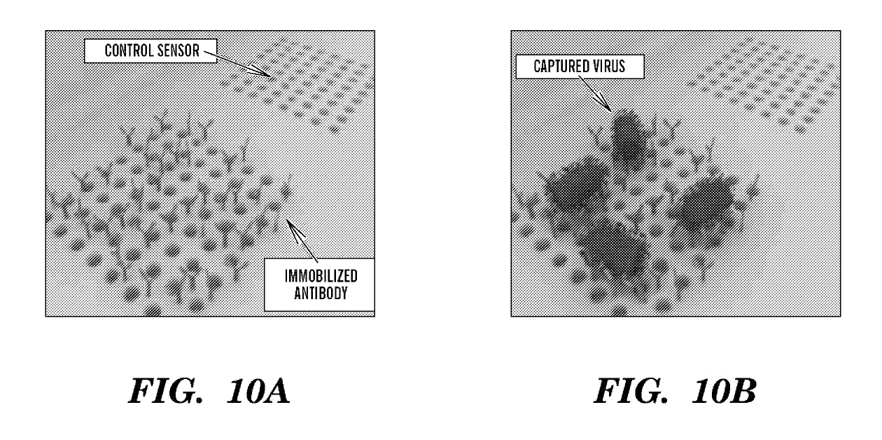

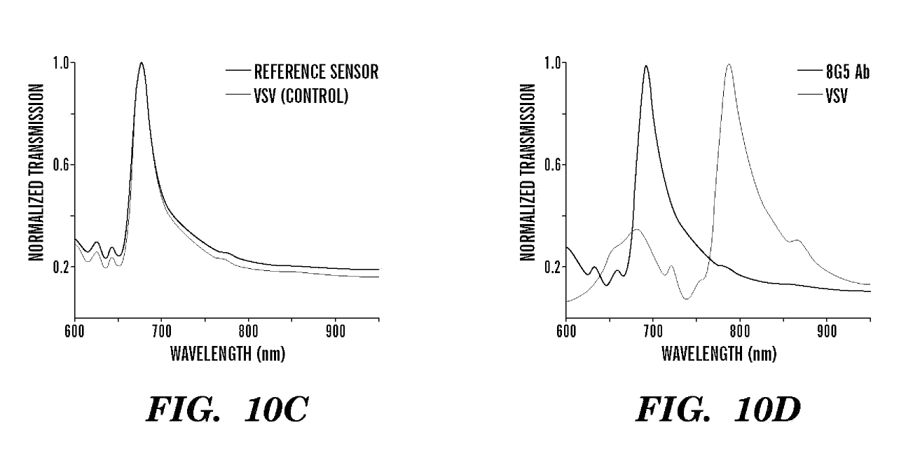

The detection scheme based on our optofluidic-nanoplasmonic sensor is illustrated in FIGS. 10A-10B. The device consists of a suspended nanohole array grating that couples the normally incident light to surface plasmons, electromagnetic waves trapped at metal/dielectric interface in coherence with collective electron oscillations^{35,47-49}. The extraordinary light transmission resonances are observed at specific wavelengths, λᵣₑₛ approximated by ⁵⁰⁻⁵³:

$${λ}_{res} \approx \frac{{a}_{0}}{\sqrt{{i}^{2} + {j}^{2}}} \sqrt{\frac{{ɛ}_{m} {ɛ}_{d}}{{ɛ}_{m} + {ɛ}_{d}}} \qquad ( 1 )$$

where the grating coupling enables the excitation of the surface plasmons (FIGS. 10C-10D). Here, a₀ is the periodicity of the array and i,j are the grating orders. This resonance wavelength is strongly correlated with the effective dielectric constant of the adjacent medium around the plasmonic sensor (Eq. 1))^{51,52}. As biomolecules/pathogens bind to the metal surface or to the ligands immobilized on the metal surface, the effective refractive index of the medium increases, and red-shifting of the plasmonic resonance occurs⁵⁴. Unlike techniques based on external labeling, such resonance shifting operate as a reporter of the molecular binding phenomena in a label free fashion and enables transduction of the capturing event directly to the far field optical signal⁵⁵⁻⁵⁷. Exponential decay of the extent of the plasmonic excitation results in subwavelength confinement of the electromagnetic field to the metal/dielectric interface⁵⁸. As a result, the sensitivity of the biosensor to the refractive index changes decreases drastically with the increasing distance from the surface, thereby minimizing the effects of refractive index variations due to the temperature fluctuations in the bulk medium⁵⁸.

FIG. 10D demonstrates a representative set of experimental end-point measurements for selective detection of vesicular stomatitis virus (VSV) at a concentration of 10⁹ PFU/ml. Here, the transmission light spectra are acquired from an optofluidic-nanohole array of 90 μm×90 μm with a periodicity of 600 nm and an aperture radius of 200 nm. Spectra are given for both before (blue curve) and after (red curve) the incubation of the virus containing samples. The sharp resonance feature observed at 690 nm (blue curve) with 25 nm full width at half maximum (FWHM) is due to the extraordinary light transmission phenomena through the optically thick gold film. This transmission resonance (blue curve) corresponds to the excitation of the (1,0) grating order SPP mode at the metal/dielectric interface of the antibody immobilized detection sensor50. After the incubation process with the virus containing sample, a strong red-shifting (˜100 nm) of the plasmonic resonance peak is observed (red curve), due to the accumulated biomass on the functionalized sensing surface. Such a strong resonance shift results in a color change of the transmitted light, which is, remarkably, large enough to discern visually without a spectrometer. For the un-functionalized control sensors (FIG. 10C), a negligible red-shifting (˜1 nm) of the resonances is observed (blue vs red curves), possibly due to the non-specific binding events. This measurement clearly demonstrates that optofluidic biosensors provide novel platforms that can be used for specific detection of viruses. At lower concentrations of viruses (<10⁸ PFU/ml) spectral shifts are more modest and require spectral measurements. However, considering that concentrations of certain types of viruses in infected samples reaches to the concentrations comparable to our visual detection limit, our platform offers unique opportunities for the development of rapid point-of-care diagnostics⁵⁹.

Device Fabrication:

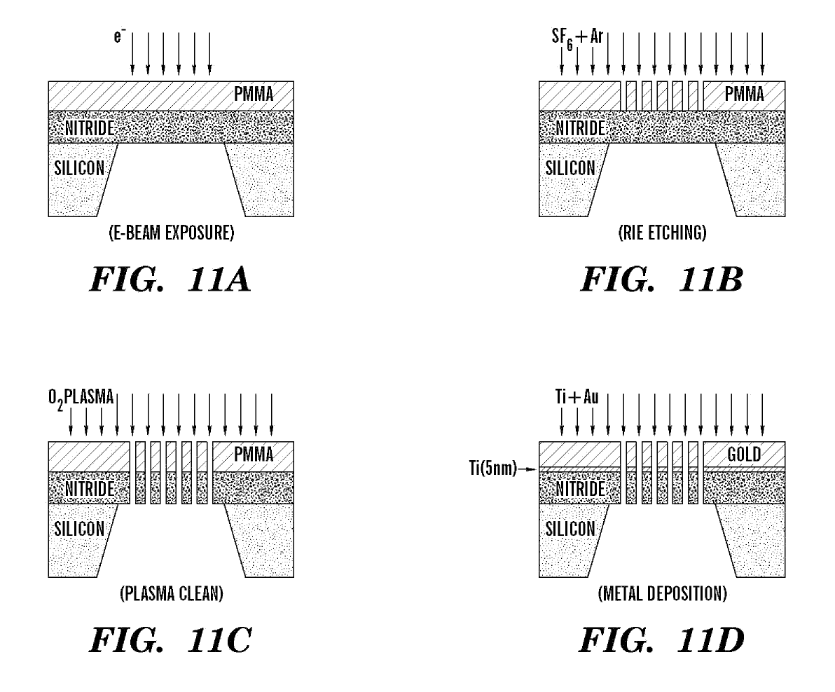

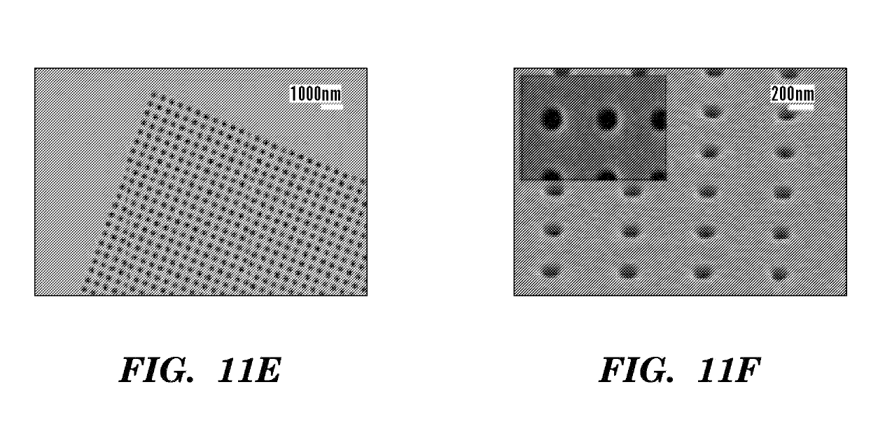

A lift-off free nanofabrication technique, based on positive resist e-beam lithography and direct deposition of metallic layers, was developed to fabricate optofluidic-plasmonic hiosensors³⁵. This scheme eliminates the need for lift-off processes, as well as operationally slow focused, ion-beam lithography, which introduces optically active ions. As a result, high quality plasmonic resonances (15-20 nm FWHM), and high figure of merits (FOM ˜40) for refractive index sensitivities, defined as shift per refractive index unit (RUI) divided by the width of the surface plasmon resonances in energy units, are achieved³⁵. The fabrication scheme is summarized in FIGS. 11A-11F. Initially, free standing SiNx membranes are created using a series of photolithographic and chemical wet etching (KOH) processes ⁶⁰. The membranes are then covered with positive e-beam resist poly(methyl methacrylate) (PMMA) and e-beam lithography is performed to define the nanohole pattern in the resist (FIG. 11A). This pattern is transferred to the SiNx membrane through a reactive ion etching process (FIG. 11B). After the removal of the resist with an oxygen plasma etching process (FIG. 11C), a photonic crystal-like free standing SiNx membrane is defined. Sequential deposition of the metal layers (5 nm Ti, 100 nm Au) results in free standing optofluidic nanoplasmonic holes transmitting light at resonance (FIG. 11D)³⁵. As demonstrated repeatedly in the experiments, this scheme allows fabrication of metallic nanohole arrays, without clogging the openings, and with extremely high yield/reproducibility and with minimal surface roughness (FIGS. 11E-11F)³⁵.

Virus Preparation.

VSV and virus pseudotypes. Baby hamster kidney (BHK) cells were cultured in Dulbecco's modified Eagle's medium (DMEM) supplemented with 7% fetal bovine serum and 2 mM glutamine. Cells were grown to 85-95% confluence and then infected with VSV (Indiana serotype, Orsay strain) in DMEM at a low multiplicity of infection (MOI=0.01). 24 hours postinfection (hpi), media was harvested and virus titer was determined by plaque assay. VSV pseudotyped to express the glycoprotein from Ebola Zaire was grown in a similar fashion, but media was harvested at 48 hpi. Purified virus was obtained through sedimentation of virus at 100,000×G for 1 hour, followed by resuspension in PBS or 10 mM Tris pH 8.0. Resuspended virus was checked for purity by SDS-PAGE and Coomassie Blue staining, aliquoted and stored at −80° C. Vaccinia virus. A549 cells were cultured in medium described above. Cells were infected with Vaccinia (WR strain) in DMEM at an MOI=0.01. 24 hpi media was harvested and virus titers were determined via plaque assay. Aliquots were stored at −80° C.

Antibodies.

Antibodies targeting the single external VSV glycoprotein (called 8G5) were a kind gift of Douglas S. Lyles (Wake Forest). Antibodies were obtained from hybridoma supernatants. Purification of 8G5 from hybridoma supernatents was accomplished by protein A purification. Antibody targeting the Ebola glycoprotein (M-DA01-A5) was kind gift of Lisa Hensley (The United States Army Medical Research Institute of Infectious Diseases-USAMRIID). Antibody against Vaccinia virus (A33L) was the kind gift of Jay Hooper (USAMRIID).

Surface Functionalization.

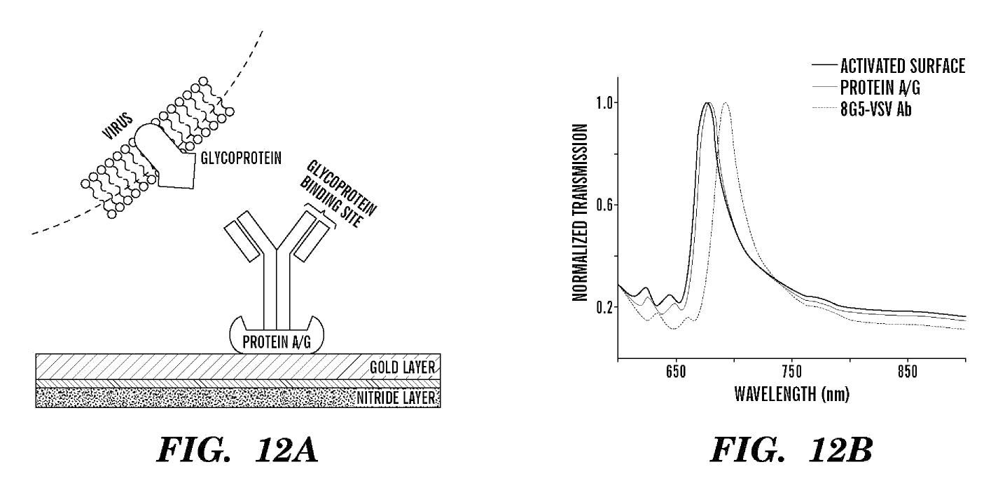

An exemplary surface functionalization scheme is summarized in FIGS. 12A-12B. In accordance with an earlier procedure for immobilization of antiviral immunoglobulins, plasmonic sensors are initially activated, after cleaning in a piranha solution (1:3 hydrogen peroxide in % 45 sulfuric acid solution for 5 min at room temperature)⁶¹. Activated surfaces are immobilized with protein A/G (Pierce, Ill.) at a concentration of 1 mg/ml in PBS (10 mM phosphate buffer, 137 mM NaCl and 2.7 ml KCl) and incubated for 90 min at room temperature. Weakly bound and unbound molecules are eliminated by washing the chips in a direct stream of deionized, 0.1 μm filtered water. Unless otherwise stated in the following, all post-incubation washing processes were performed in three steps consisting of 5 minutes each PBST, PBS, filtered DI water washing and blow drying with nitrogen. Protein A/G was chosen as a template for the immobilization of the virus specific anti-bodies due to its high affinity to the Fc region of the IgG molecules^{62,63}. Protein-AG is a recombinant fusion protein that contains the four Fc binding domains of protein A and two of the Protein G Unlike protein A, the binding of chimeric protein A/G is less dependent upon the pH. The elimination of the non-specific binding regions to the serum proteins (including albumin) makes it an excellent choice for immobilization of the immunoglobulins. Proper orientation of the antibodies is imposed by this template (FIG. 12A)⁶³.

Antibody Immobilization.

Specific detection of viruses in a label free fashion requires an effective method to distinguish non-specific binding of the viruses to the optofluidic-plasmonic sensor surface. Selectivity is achieved by surface immobilized highly specific antiviral immunoglobulins showing strong affinity to the viral membrane proteins, called glycoproteins (GP)⁶⁴. GPs are presented on the outside of the assembled virus membrane and bind to receptors on the host cell membrane in order to enter into the cell (FIG. 12A). Complementary antibodies (8G5 to recognize VSV⁶⁵⁻⁶⁶, M-DA01-A5 to recognize Ebola (kind gifts from Lisa Hensley at USAMRIID) and A33L (a kind gift from Jay Hooper at USAMRIID⁶⁷) having strong affinity to the GPs of the relevant viruses (VSV, pseudotyped Ebola, Vaccinia) were spotted on an array of sensors fabricated on a single chip at a concentration of 0.5 mg/ml in PBS (FIG. 12A). The sensitivity of any immunoassay is highly dependent on the spotting of the antibodies. Higher concentrations of antiviral antibodies with respect to the virion concentrations are needed [virion]<[IgG], so that the spectral shift is proportional to the concentration of the virions instead of being limited by the antiviral immunoglobulin concentration⁶⁸. After a 60 min of incubation, unbound antibody was removed by a three step post-incubation washing process. No blocking agent was needed to block the antibody-free protein A/G surface, since the viruses do not directly bind to the protein A/G functionalized surface⁶¹.

The successful functionalization of the sensing surface is monitored with end-point measurements after each incubation and washing processes. As shown in FIG. 12B, the accumulated biomass on the sensing surface results in red-shifting of the air (1,0) resonance (black curve) due to the increasing local refractive index at the metal/dielectric of interface of the nanoplasmonic biosensor. Initially, a red shifting for about 4 nm was observed (blue curve), after the protein A/G functionalization in accordance with the procedure outline above. Protein A/G template is later used to immobilize (in this case) the 8G5-VSV specific antibodies at a concentration of 0.5 mg/ml. A spectral shift of 14 nm (red curve) is observed after the antibody immobilization, confirming the successful functionalization of the surface.

Reference Sensors.

Reference sensors were incorporated into the chip design to correct for any drift and noise signal due to the unexpected changes in the measurement conditions or nonspecific binding events. Two different types of control spots, one functionalized with protein A/G only and one without any functionalized biomolecules, were used to determine the optimum configuration for the reference sensors. For the reference sensors functionalized with protein-A/G, it was observed that after the introduction of the antibodies to the detection spots, a red-shifting of the resonance is observed. This observation is associated to the relocation of the anti-viral immunoglobulins during the washing processes from antibody immobilized spots to the protein A/G immobilized reference sensors as a result of the high affinity of the protein A/G to the IgG antibodies. For the reference spots with no protein A/G layer, red shifting of the resonance after the introduction of the viruses was minimal. Accordingly, unfunctionalized nanohole sensors were used for reference measurements.

PT-Ebola and Vaccinia Virus Detection.

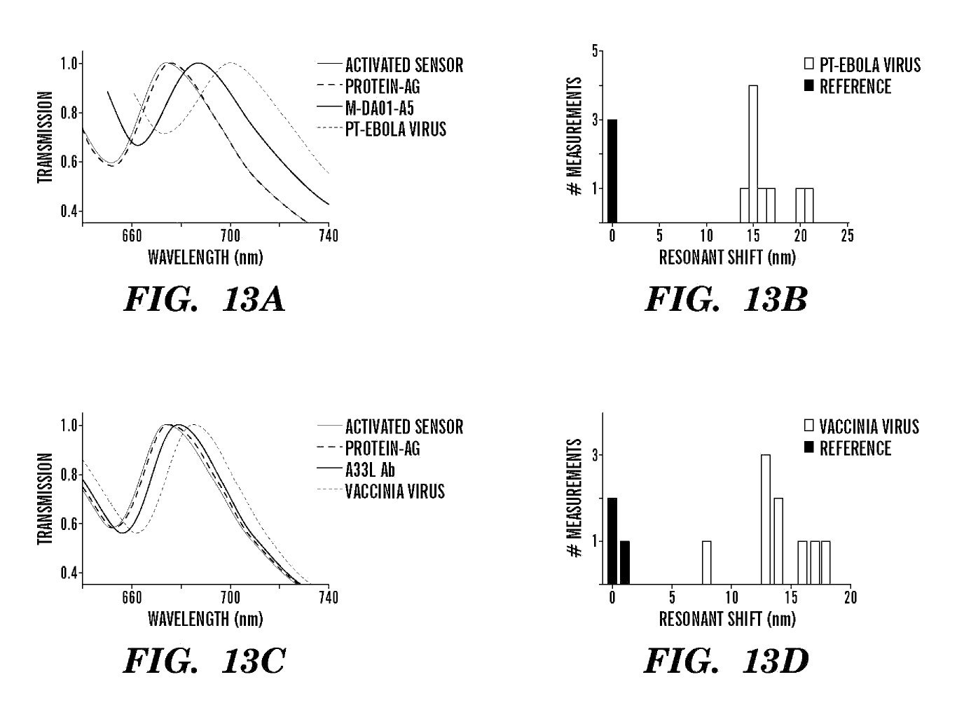

To determine the broad adaptability of our platform to different types of viruses, we tested the sensors with hemorrhagic fever viruses (like Ebola virus) and poxviruses (like monkeypox or variola, the causative agent of smallpox). These viruses are of particular interest to public health and national security. Though we were not able to directly test these viruses because of biosafety considerations, we use a pseudotyped-VSV, where the Ebola glycoproteins are expressed on the virus membrane instead of the VSV's own glycoprotein⁷⁰. Pseudotyped-Ebola virus (PT-Ebola) is a viable surrogate to analyze the behavior of Ebola, since the expressed glycoprotein folds properly and is fusion competent. The pseudotyped viruses have been successfully used as vaccine against Ebola in nonhuman primate models and can be used at lower biosafety levels (BSL2 versus BSL4). For these experiments, antibody against the Ebola glycoprotein was immobilized on the 9 of 12 sensors on a single chip, while 3 sensors were reserved for reference measurements. Successful functionalization of the protein-A/G and the antibodies were confirmed by spectral measurements (FIG. 4A). Following the immobilization of the antibodies, PT-Ebola (at a concentration of 10 PFU U/ml) in a PBS buffer solution) was added onto the chips and incubated for 90 min. After the washing process as summarized above, transmission spectra were collected (FIG. 13A). Consistent red-shifting of the plasmonic resonances were observed on antibody-coated spots indicating PT-Ebola detection (>=14 nm red shift), while control sensors showed no spectral shift (red bars, FIG. 13B). This occurred with high repeatability (9 of 9 sensors) and excellent signal to-noise ratios. Similarly, we tested our platform for the detection of enveloped DNA poxviruses. To do this, we utilized Vaccinia virus, a poxvirus that is commonly used as a prototype for more pathogenic viruses such as smallpox and monkeypox⁷¹. A similar approach (Vaccinia antibody to the A33L external protein immobilized on 9 of 12 sensors, incubation with intact vaccinia virus at the same concentration of 108 PFU/ml) yielded similar positive results to those seen with PT-Ebola virus (FIG. 13C). All of the 9 sensors detected the virus, while none of the control sensors indicated more than minimal binding (FIG. 13D). For sensors close to the spotted sample edges, both weaker (8 nm in the case of Vaccinia virus) and stronger (20-21 nm in the case of pseudo-Ebola virus) spectral shifts were observed. This is related to the varying concentrations of viruses due to the edge effects created when the virus sample is spotted. Measurements obtained from multiple sensors improved the robustness of the assay. Repeatability of the measurements was readily observed; all functionalized nanohole sensors showed a consistent shift ranging from 14-21 nm (FIGS. 13B, 13D). This observation shows a clear quantitative relation between the spectral shifts and virus concentrations. Such quantification is not possible with techniques based on fluorescent labeling (ELISA). Although Vaccina virus is relatively larger than the pseudo-Ebola viruses, comparable spectral shifts are observed for the pseudo-Ebola viruses. This observation clearly indicates that the capturing efficiency of the viruses, thus the accumulated biomass, is not only controlled by the concentrations of the virions but also controlled by the affinity of the virus-IgG interactions⁷². Without doubt, strength of such interactions is strongly affected by the complex mixture of the envelope proteins and the surroundings of the viral subunits^{72,73}. In fact, the structure and the conformation state of the membrane incorporated glycoproteins may strongly differ from those of the purified ones⁷². Accordingly, techniques based on detection of recombinant and refined virus specific proteins or viral peptides are not suitable for medical studies of in-vivo behavior of live viruses. Instead, techniques enabling direct detection of entire viral particles in medically relevant biological media are needed. While most studies in this field are confined to detection of individual viral components such as glycoproteins and nucleic acids, we demonstrate that our detection platform enables direct detection of entire viruse ^{73,74}.

Virus Detection in Biological Media.

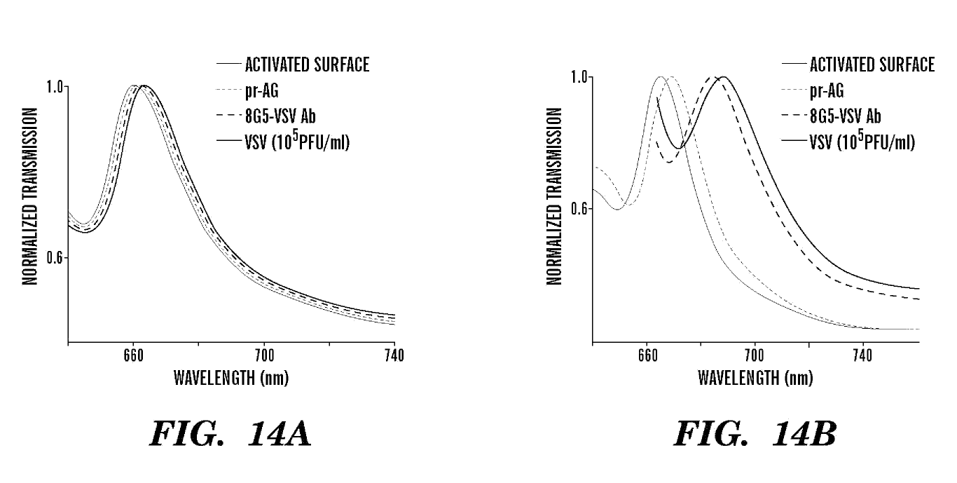

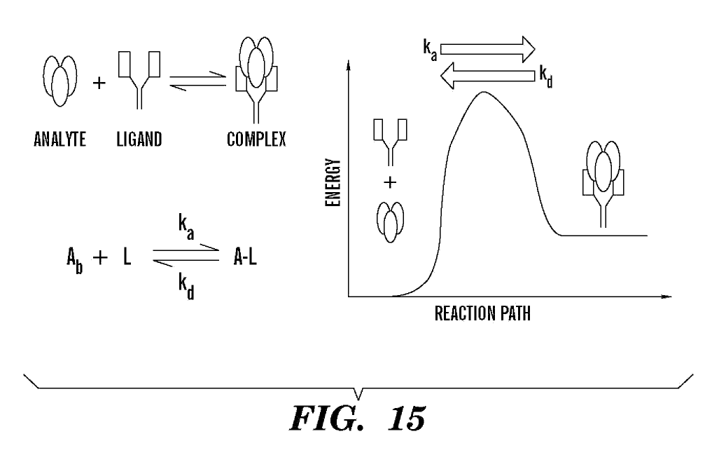

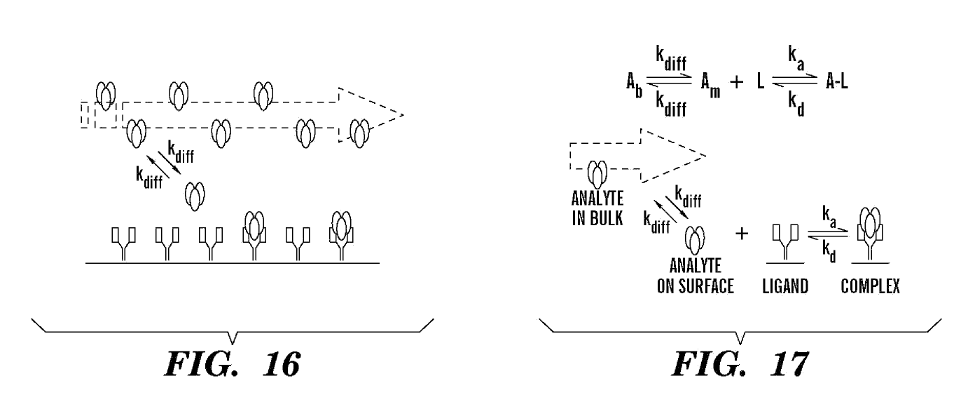

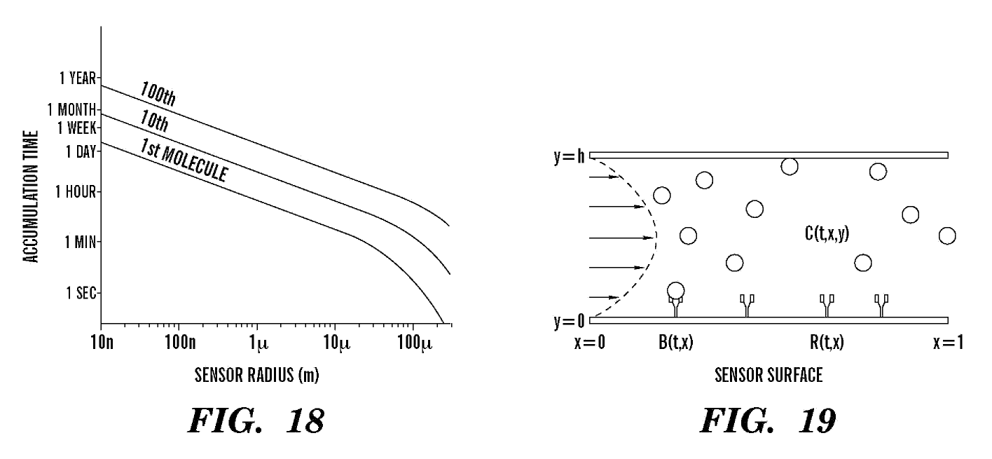

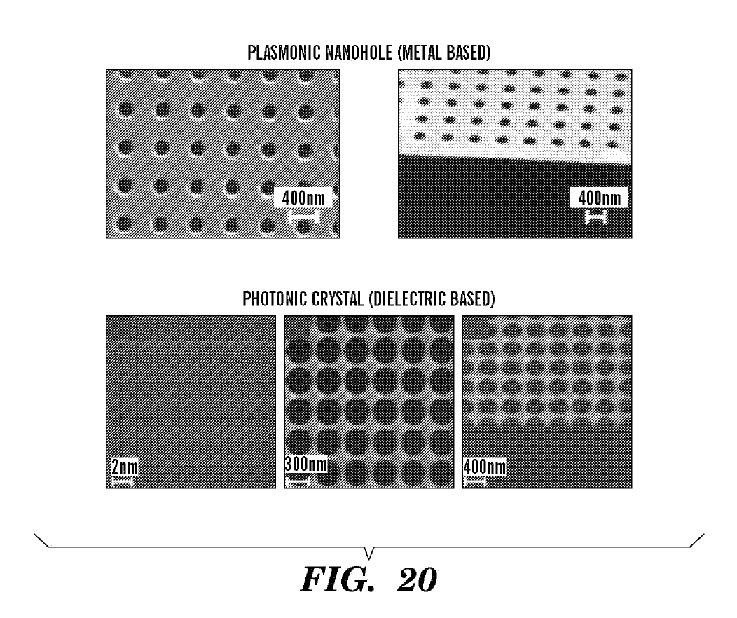

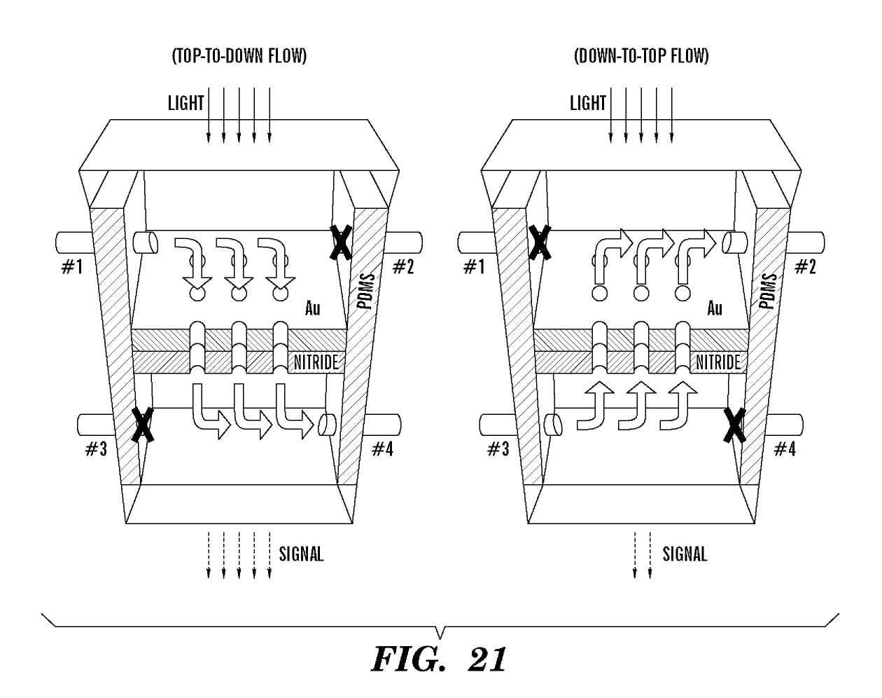

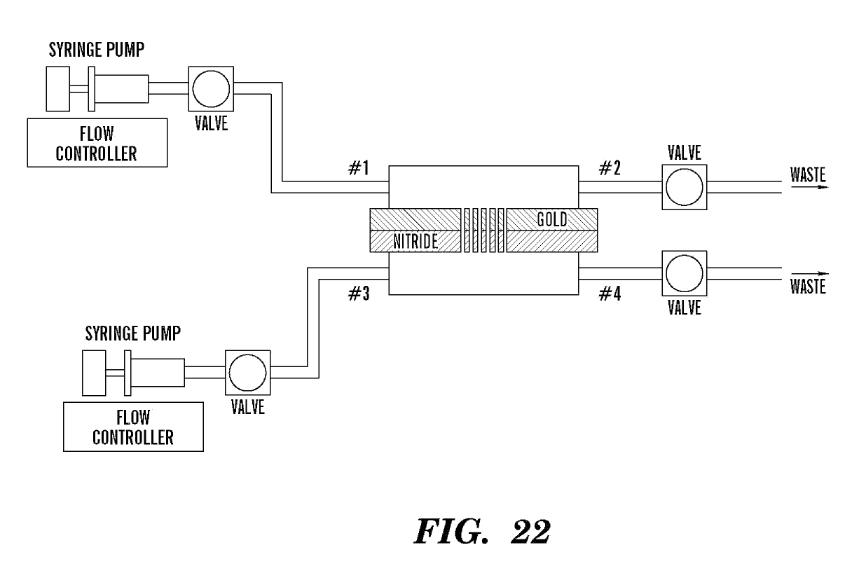

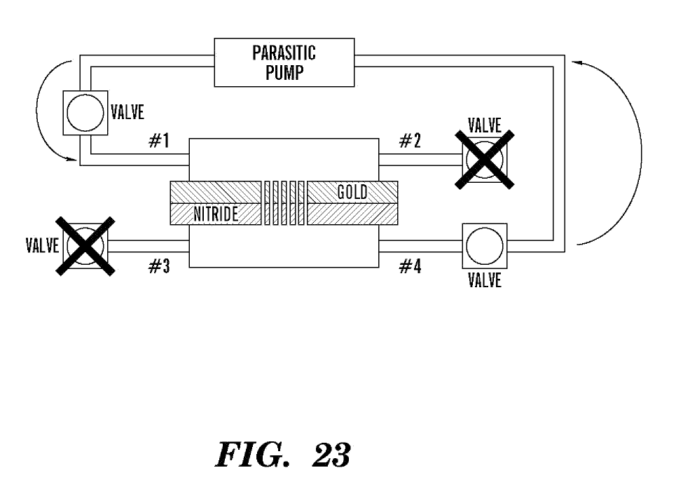

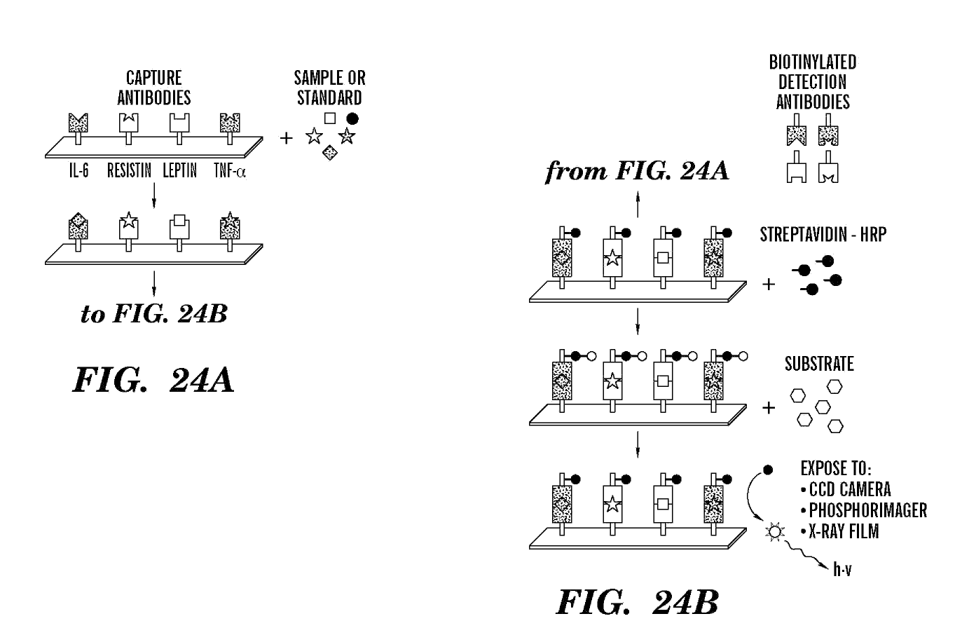

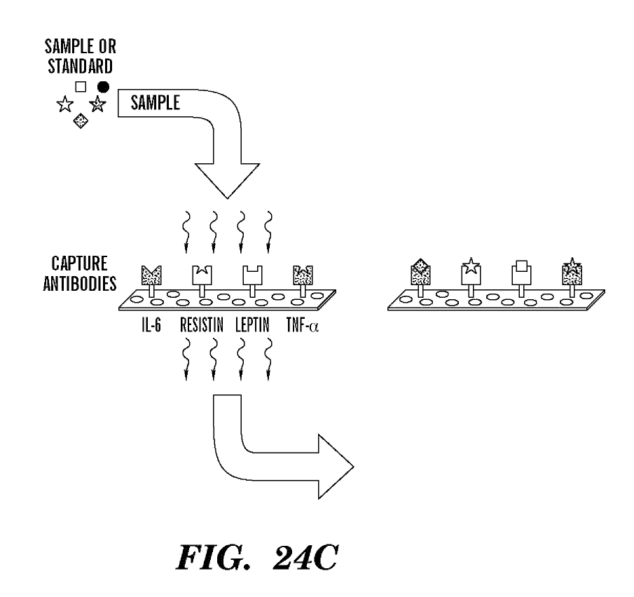

To demonstrate the applicability of our detection platform in biologically relevant systems, we extended our experiments to detection of intact viruses directly from biological media (cell growth medium +7% fetal calf serum). These conditions provide a number of potentially confounding factors (high serum albumin levels, immunoglobulins and growth factors) that could add unwanted background signal, thus this was an important test for the robustness of our detection system. In FIGS. 14A-14B, it is shown that the initial Pr-AG functionalization (1 mg/ml) resulted in 4 nm red shifting of the resonances. Subsequently, anti-VSV (0.5 mg/ml) immobilization was confirmed with the ˜15 nm red shifting of the resonances. Finally, VSV was applied to the chips at a concentration of 10⁶ PFU/ml in a DMEM/FBS medium. Measurements, following an incubation period of 90 min and post washing processes, showed a 4 nm resonance shift for the anti-viral immunoglobin functionalized spots. In control sensors, red-shifting of the resonances was seen, but was limited to only 1.3 nm due to the non-specific binding of the serum proteins. The specific capturing of the intact viruses at a low concentration of 10⁶ PFU/ml is clearly distinguishable at the antibody functionalized sensors. This observation demonstrates the potential of this platform for clinical applications. Due to our ability to quantify non-specific binding on an individual chip, the presence of a small amount of background does not pose a fundamental bottleneck for the viability of this technology. In fact, this technology is sufficient for microbiology laboratories involving culturing of the viruses. In addition, it is likely that the technology can be adapted “as is” for successful diagnosis of herpesvirus, poxvirus and some gastroenteric infections, since a detection limit of 10⁷-10⁸ PFU/ml is usually sufficient for clinical applications⁵⁹. Given that the resolution limit of detection system is 0.05 nm, it is likely that much lower concentrations can be detected with the current platform. Background shifting due to the non-specific binding could be a problem at lower concentrations of analytes (<10⁵ PFU/ml), however this limitation can be considerably reduced and significant improvements in detection limits of the devices can be achieved by optimizing the surface chemistry.

Conclusion.

The studies described herein provide biosensing platforms and methods of use thereof for fast, compact, quantitative and label free sensing of biomolecular targets, such as viral particles, with minimal sample processing. We demonstrate that the extraordinary light transmission phenomena on plasmonic nanohole arrays can be adapted for pathogen detection without being confounded by surrounding biological media. In some embodiments, the sensing platform uses antiviral immunoglobulins immobilized at the sensor surface for specific capturing of the intact virions and is capable of quantifying their concentrations. Direct detection of different types of viruses (VSV, pseudo-Ebola and Vaccinia) are shown. A dynamic range spanning three orders of magnitude from 10⁶ PFU/ml to 10⁹ PFU/ml is shown in experimental measurements corresponding to virion concentration within a window relevant to clinical testing to drug screening. Moreover, detection of the viruses at low concentrations in biologically relevant media at detection limits <10⁵ PFU/ml clearly demonstrates the feasibility of the technology for earlier diagnosis of viruses directly from the human blood. It is important to note that the ease of multiplexing afforded by this approach is a crucial aspect of the biosensor design. The optofluidic-plasmonic sensors can be readily expanded into a multiplexed format, where the various viral antibodies are immobilized at different locations to selectively detect the pathogens in an unknown sample. The advantage of the optofluidic-plasmonic sensor is its ability to detect intact virus particles and identify them without damaging the virus structure or the nucleic acid load (genome), so that the samples can be further studied ⁴⁶. The approaches described herein open up biosensing applications of extra-ordinary light transmission phenomena for a broad range of pathogens, and can be directly utilized in any biology lab.

### REFERENCES

1. Potter, C. W. J. Appl Microbiol. 2001, 91, 572-579.
2. Tseng, D.; Mudanyali, O.; Oztoprak, C.; Isikman, S. O.; Sencan, I.; Yaglidere, O.; Ozcan, A. Lab Chip 2010, 10, 1787-1792.
3. Henkel, J. H.; Aberle, S. W.; Kundi, M.; Popow-Kraupp, T. J. Med. Virol. 1997, 53, 366-371.
4. Bao, P. D.; Huang, T. Q.; Liu, X. M.; Wu, T. Q. J. Raman Spectrosc. 2001, 32, 227-230.
5. Karst, S. M. Viruses 2010, 2, 748-781.
6. Jones, L. J.; Upson, R. H.; Haugland, N.; Panchuk-Voloshina, M.; Zhou J.; Haugland, R. P. Anal. Biochem. 1999, 271, 119-120.
7. Drosten, C.; Panning, M.; Guenther, S.; Schmitz, H., J Clin Microbiol 2002, 40, 2323-2330.
8. Gaydos, C. A.; Crotchfelt, K. A.; Howell, M. R.; Kralian, S.; Hauptman, P.; Quinn, T. C. J. Infect. Dis., 1998, 117, 417.
9. Liebert, U. Intervirology 1997, 40, 176.
10. Schneider-Schaulies, J.; Meulen, V.; Schneider-Schaulies, S. J. Neurovirol. 2003, 9, 247.
11. Towner, J. S.; Sealy, T. K.; Khristova, M. L.; Albarino, C. G.; Conlan, S.; Reeder, S. A.; Quan, P. L.; Lipkin, W. I.; Downing, R.; Tappero, J. W.; Okware, S.; Lutwama, J.; Bakamutumaho, B.; Kayiwa, J.; Corner, J. A.; Rollin, P. E.; Ksiazek, T. G.; Nichol. S. T. PLoS Pathog, 2008, 4, e1000212.
12. Surbhi, L.; Stephan, L.; Naomi, J. H. Nature Photonics, 2007, 1, 641-648.
13. Sandra, B.; Carly, S. L.; Muhammed, G.; Bruce J.; Rozell, C.; Johnson, D. H.; Naomi, J. H. Nano Letters 2006, 6, 1687-1692.
14. Anker, J. N.; Hall, W. P.; Lyandres, O.; Shah, N. C.; Zhao, J.; Van Duyne, R. P. Nature Mater. 2008, 7, 442.
15. Homola, J. Anal. Bioanal. Chem. 2003, 377, 528-539.
16. Arnold, S.; Khoshsima, M.; Teraoka, I.; Holler S.; Vollmer, F. Opt. Lett. 2003, 28, 272-27.
17. Armani, A. M.; Kulkarni, R. P.; Fraser, S. E.; Flagan R. C.; Vahala, K. J. Science 2007, 317, 783-787.
18. Savran, C. A.; Knudsen, S. M.; Ellington, A. D.; Manalis, S. R. Analytical Chemistry, 2004, 76, 3 194-3198.
19. Joonhyung, L.; Jaesung, J.; Demir, A,; Cagri, A. S.; Bashir, R. Appl Phys Lett. 2008. 93, 013901.
20. Fritz, J.; Baller, M. K.; Lang, H. P.; Rothuizen, H.; Vettiger, P.; Meyer, E.; Güntherodt, H.; Gerber, C.; Gimzewski, J. K. Science 2000, 288, 316-318.
21. Savran, C. A.; Knudson, S. M.; Ellington, A. D.; Manalis, S. R. Analytical Chemistry, 2004, 76 3194.
22. Cui, Y.; Wei, Q. Q.; Park, H. K.; Lieber, C. M.; Science 2001, 293, 1289-1292.
23. Yuri, L. B.; Young, S. S.; Woon-Seok Y.; Michael, A.; Gabriel K.; James, R. H. J. Am. Chem. Soc. 2006, 128, 16323-16331.
24. Terrel, M.; Digonnet, M. J. F.; Fan, S. Applied Optics 2009, 48, 4874-4879.
25. Pineda, M. F.; Chan, L. L.-Y. Chan; Kuhlenschmidt, T.; Choi, C. J.; Kuhlenschmidt, M.; Cunningham, B. T. IEEE Sensors Journal, 2009, 9, 470-477.
26. Lee, J.; Icoz, K.; Roberts, A.; Ellington A. D.; Savran, C. A. Analytical Chemistry, 2010, 82, 197-202.
27. Gupta, A. K.; Nair, P. R.; Akin, D.; Ladisch, M. R.; Broyles, S.; Alam, M. A.; Bashir, R. Proc Natl Acad Sci USA. 2006, 103, 13362-13367.
28. Stern, E.; Wagner, R.; Sigworth, F. J.; Breaker, R.; Fahmy, T. M.; Reed, M. A. Nano Lett. 2007, 7, 3405-3409.
29. Yang, J-C.; Ji, J.; Hogle, J. M.; Larson, D. N.; Biosensors and Bioelectronics, 2009, 24, 23 34-2338.
30. Lesuffleur, A.; Im, H.; Lindquist, N. C.; Oh, S. H. Appl. Phys. Lett. 2007, 90, 243110.
31. Matthew, E.; Stewart, N.; Mack, H.; Malyarchuk, V.; Soares, J. A. N. T.; Lee T-W.; Gray, S. K.; Nuzzo, R. G.; Rogers, J. A. Proc Natl Acad Sci USA. 2006, 103, 17143-17148.
32. Brolo, A. G.; Gordon, R.; Leathem, B.; Kavanagh, K. L. Langmuir 2004, 20, 4813-4815.
33. Yanik, A. A.; Wang, X.; Erramilli, S.; Hong, M. K.; Altug, H. Appl. Phys. Lett. 2008, 93, 081104.
34. Yanik, A. A.; Adato, R.; Erramilli, S.; Altug, H. Optics Express, 2009, 17, 20900-209 10.
35. Yanik, A. A.; Huang, M.; Artar, A.; Chang, T-Y.; Altug, H. Appl. Phys. Lett. 2010, 96, 021101.
36. Sheehan, P. E.; Whitman, L. J. Nano Lett. 2005, 5, 803.
37. Squires, T. M.; Messinger, R. J.; Manalis, S. R.; Nat. Biotechnol. 2008, 26, 417. 38.
38. Liedberg, B.; Lundstrom, I.; Stenberg, E.; Sens. Actuators B 1993, 11, 63-72.
39. Snopok, B. A.; Kostyukevych, K. V.; Rengevych, O. V.; Shirshov, Y. M.; Venger, E. F.; Kolesnikova, I. N.; Lugovskoi, E. V. Semicond. Phys., Quantum Electron. Optoelectron. 1998, 1, 121.
40. Zia, R.; Selker, M. D.; Brongersma, M. L. Phys. Rev. B. 2005, 71, 165431.
41. Bray, M. Antiviral Res 2003, 57, 53-60.
42. Suzuki, Y.; Gojobori, T. Molecular Biology and Evolution 1997, 14, 800-806.
43. Drosten, C.; Kummerer, B. M.; Schmitz, H.; Gunther, S. Antiviral Research 2003, 57, 61-87.
44. Yu, J. S.; Liao, H. X.; Gerdon, A. E.; Huffman, B.; Scearce, R. M.; McAdams, M.; Alam, S. M.; Popernack, P. M.; Sullivan, N. J.; Wright, D.; Cliffel, D. E.; Nabel, G. J.; Haynes. B. F. J Virol Methods 2006, 137, 219-28.
45. Tucker, J. B. The Once and Future Threat of Smallpox New York: Grove/Atlantic Inc., 2001.
46. Kjeldsberg, E. J Virol Methods. 1986, 34, 321-333.
47. Catrysse, P. B.; Fan, S. Journal of Nanophotonics 2008, 2, 021790.
48. Shvets, G.; Trendafilov, S.; Pendry, J. B.; Sarychev, A. Phys. Rev. Lett. 2007, 99, 053903.
49. Ekinci Y.; Solak, H. H.; David, C. Optics Letters, 2007, 32, 172-174.
50. Ebbesen, T. W.; Lezec, H. J.; Ghaemi, H. F., Thio, T.; Wolff, P. A. Nature, 1998, 391, 667.
51. Barnes, W. L.; Murray, W. A.; Dintinger, J.; Devaux, E.; Ebbesen, T. W. Phys. Rev. Lett. 2004, 92, 107401.
52. Liu, H.; Lalanne, P. Nature, 2008, 452, 728.
53. Artar, A.; Yanik, A. A.; Altug, H. Appl. Phys. Lett., 2009, 95, 051105.
54. Tetz, K.; Pang, L.; Fainman, Y. Opt. Lett. 2006, 31, 1528.
55. Adato, R.; Yanik, A. A.; Amsden, J. J.; Kaplan, D. L; Omenetto, F. G.; Hong, M. K.; Erramilli, S.; Altug, H. Proc Natl Acad Sci USA. 2009, 106, 19227-19232.
56. Cubukcu, E.; Zhang, S.; Park, Y-S.; Bartal, G.; Zhang, X. Appl. Phys. Lett., 2009, 95, 043113.
57. Cubukcu, E.; Degirmenci, F.; Kocabas, C.; Zimmler, M. A.; Rogers, J. A.; Capasso, F. Proc Natl Acad Sci USA. 2009, 106, 8.
58. Shumaker-Parry, J. S.; Campbell, C. T. Anal. Chem. 2004, 76, 907-9 17.
59. Hazelton, P. R.; Gelderblom, H. R. Emerg. Infec. Dis. 2003, 9, 294.
60. Huang, M.; Yanik, A. A.; Chang T-Y.; Altug H. Optics Express 2009, 17, 24224-24233.
61. Nettikadan, S. R.; Johnson, J. C.; Vengasandra, S. G.; Muys J.; Henderson, E. Nanotechnology 2004, 15, 383.
62. Eliasson, M.; Andersson, R.; Olsson, A.; Wigzell, H.; Uhlen, M. J. Biol. Chem. 1988, 263, 4323-4327.
63. Chackerian, B.; Briglio, L.; Albert, P. S.; Lowy, D. R.; Schiller, J. T. J. Virol. 2004, 78, 4037-4047.
64. Dimmock, N.; Easton, A.; Leppard, K. Introduction to Modern Virology; Wiley-Blackwell, 2007.
65. Lefrancois, L.; Lyles. D. S. J Immunol 1983, 130, 394-398.
66. Lefrancois, L.; Lyles, D. S. Virology 1982, 121, 168-174.
67. Golden, J. W.; Hooper, J. W. Virology 2008, 377, 19-29.
68. Boltovets, P. M.; Snopok, B. A.; Boyko, V. R.; Shevchenko, T. P.; Dyachenko, N. S.; Shirshov, Y. M. J Virol Methods 2004, 121, 101-106.
69. Drazen, J. M. N Engl J Med 2002, 346, 1262-1263.
70. Garbutt, M.; Liebscher, R.; Wahl-Jensen, V.; Jones, S.; Moller, P.; Wagner, R.; Volchkov, V.; Klenk, H. D.; Feldmann, H.; Stroher, U. J Virol, 2004, 78, 5458-5465.
71. Moss, B. Poxyiridae: The Viruses and Their Replication. In D. M. H. Knipe, P. M. (ed.), Fields Virology, 5 ed, vol. 2. Lippincott Williams & Wilkins, 2007.
72. Schoefield, D. J.; Dimmock, N. J. J. Virol. Methods 1996, 62, 33-42.
73. Wittekindt, C.; Fleckenstein, B.; Wiesmuller, K.; Eing, B. R.; Kuhn, J. E. J. Virol. Methods 2000, 87, 133-144.
74. Tanaka, Y.; Shimoike, T.; Ishii, K.; Suzuki, R.; Suzuki, T.; Ushijima, H.; Matsuura, Y.; Miyamura, T. Virology 2000, 270, 229-236.

It should be understood that processes and techniques described herein are not inherently related to any particular apparatus and may be implemented by any suitable combination of components. The present invention has been described in relation to particular examples, which are intended in all respects to be illustrative rather than restrictive. Those skilled in the art will appreciate that many different combinations will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A plasmonic nanostructure biosensor comprising a substrate and a metal film disposed on the substrate, wherein said metal film comprises one or more surfaces comprising a plurality of nanoelements arranged in a predefined pattern, wherein each of said nanoelements has a dimension less than one wavelength of an incident optical source to which said metal film produces surface plasmons, and wherein said metal film is activated with an activating agent.

2. The plasmonic nanostructure biosensor of claim 1, wherein the substrate comprises silicon, silicon dioxide, silicon nitride, glass, diamond, quartz, magnesium fluoride (MgF₂), calcium fluoride (CaF₂), ZnSe, germanium, or a polymer.

3. The plasmonic nanostructure biosensor of claim 1, wherein the metal film produces surface plasmons to incident light in the UV-VIS-IR spectral range.

4. The plasmonic nanostructure biosensor of claim 1, wherein the metal is a Noble metal, a transition metal, or an alkali metal.

5. (canceled)

6. The plasmonic nanostructure biosensor of claim 1, wherein the metal film is between 50-500 nm thick.

7. (canceled)

8. The plasmonic nanostructure biosensor of claim 1, wherein the nanoelement is a nanohole.

9. (canceled)

10. (canceled)

11. (canceled)

12. The plasmonic nanostructure biosensor of claim 1, wherein the predefined pattern is a periodic pattern.

13. The plasmonic nanostructure biosensor of claim 12, wherein the plurality of nanoelements are separated by a periodicity of between 100-1000 nm.

14. (canceled)

15. (canceled)

16. The plasmonic nanostructure biosensor of claim 1, further comprising an adhesion layer, wherein the adhesion layer is between the metal film and the substrate.

17. (canceled)

18. The plasmonic nanostructure biosensor of claim 16, wherein the adhesion layer is less than 50 nm thick.

19. (canceled)

20. (canceled)

21. The plasmonic nanostructure biosensor of claim 1, wherein the activated metal film is further functionalized with one or more capture agents.

22. (canceled)

23. The plasmonic nanostructure biosensor of claim 21, wherein the one or more capture agents comprise a first capture agent and second capture agent, wherein the first capture agent is specific for the second capture agent, and the second capture agent is specific for one or more biomolecular targets.

24. (canceled)

25. (canceled)

26. A plasmonic nanostructure biosensor system for detecting one or more biomolecular targets comprising:
(i) a plasmonic nanostructure biosensor comprising a substrate and a metal film disposed on the substrate, wherein said metal film comprises one or more surfaces comprising a plurality of nanoelements arranged in a predefined pattern, wherein each of said nanoelements has a dimension less than one wavelength of an incident optical source to which said metal film produces surface plasmons, and wherein said metal film is activated with an activating agent;
(ii) a device for contacting one or more samples comprising one or more biomolecular targets to the metal film surface(s) of the plasmonic nanostructure biosensor;
(iii) an incident light source for illuminating a surface of said metal film to produce said surface plasmons; and
(iv) an optical detection system for collecting and measuring light displaced from said illuminated metal film, wherein said displaced light is indicative of surface plasmon resonance on one or more surfaces of said metal film.

27. The plasmonic nanostructure biosensor system of claim 26, wherein the device for contacting one or more samples comprises a fluidic system.

28. A method for detecting one or more biomolecular targets comprising:
(i) providing a plasmonic nanostructure biosensor system comprising:
a. a plasmonic nanostructure biosensor comprising a substrate and a metal film disposed on the substrate, wherein said metal film comprises one or more surfaces comprising a plurality of nanoelements arranged in a predefined pattern, wherein each of said nanoelements has a dimension less than one wavelength of an incident optical source to which said metal film produces surface plasmons, and wherein said metal film is activated with an activating agent;
b. a device for contacting one or more samples comprising one or more biomolecular targets to the metal film surface(s) of the plasmonic nanostructure biosensor;
c. an incident light source for illuminating a surface of said metal film to produce said surface plasmons; and
d. an optical detection system for collecting and measuring light displaced from said illuminated metal film, wherein said displaced light is indicative of surface plasmon resonance on one or more surfaces of said metal film;
(ii) contacting one or more samples comprising one or more biomolecular targets to the metal film surface of the plasmonic nanostructure biosensor;
(iii) illuminating one or more surfaces of the metal film of the plasmonic nanostructure biosensor with the incident light source to produce surface plasmons, before and after the contacting with the one or more samples;
(iv) collecting and measuring light displaced from the illuminated film with the optical detection system, before and after the contacting with the one or more samples; and
(v) detecting the one or more biomolecular targets based on a change or difference in the measurement of the light displaced from the illuminated film before and after the contacting with the one or more samples.

29. The method of claim 28, wherein the biomolecular target is a eukaryotic cell, a eukaryotic cellular component, a prokaryotic cell, a prokaryotic cellular component, a viral particle, a protein, an oligonucleotide, a prion, a toxin, or any combination thereof.

30. The method of claim 28, wherein said collected light comprises light in a transmission mode, in a reflection mode, or a combination thereof.

31. The method of claim 28, wherein the step of measuring displaced light comprises measuring light over a spectral range selected to comprise at least one plasmon band.

32. The method of claim 28, wherein the change in the measurement of the displaced light before and after the contacting is a resonance peak shift, a change in a resonance peak intensity, a broadening of a resonance peak, a distortion in resonance of peak, or a change in refractive index.

33-79. (canceled)
